(19) United States
(12) Patent Application Publication
(10) Pub. No.: US 2026/0352122 A1
(43) Pub. Date: Nov. 5, 2026

(54) A METHOD OF MANUFACTURING AN ACTIVE LAYER FOR A TRIBOELECTRIC NANOGENERATOR (TENG)

(71) Applicant: INTEGRATED GRAPHENE HOLDING LIMITED, Stirling (GB)

(72) Inventors: Marco CAFFIO, Stirling (GB); Oliver SEMPLE, Stirling (GB); Darren CAIRNS, Stirling (GB)

(21) Appl. No.: 19/486,516

(22) PCT Filed: May 22, 2024
(86) PCT No.: PCT/GB2024/051320

§ 371 Date: Nov. 21, 2025

(30) Foreign Application Priority Data
May 22, 2023 (GB) 2307616.9

(51) Int. Cl. H02N 1/04; B23K 26/402

(52) U.S. Cl. CPC H02N 1/04; B23K 26/402

(57) ABSTRACT

A triboelectric nanogenerator (TENG) uses a carbon foam based electropositive layer. The carbon foam is made using a dual laser process in which: (a) a first laser beam irradiates an encapsulated, sub-surface region of a carbon pre-cursor material below a surface of the carbon pre-cursor material, to create carbon foam in that encapsulated, sub-surface region, and then (b) a second laser beam (i) removes or ablates material sitting above the carbon foam, and (ii) exposes the carbon foam and thereby produce the resultant carbon foam material that is used as the electropositive layer in the TENG.

### FIELD OF THE INVENTION

This invention relates to a method of manufacturing an active layer for a triboelectric nanogenerator (TENG). The active layer is made of a carbon foam material produced using a laser-based manufacturing process.

### Background to TENGS

Triboelectric nanogenerators (TENGs) convert mechanical energy into electric power using the triboelectric effect: TENGs create electric power when two electrically dissimilar materials come into contact and then separate. TENGs have three basic operation modes: vertical contact-separation mode, in-plane sliding mode, and single-electrode mode; each mode has different characteristics and is suitable for different applications.

TENGs have emerged as a promising technology to harvest mechanical energy from movement, such as low-frequency vibrations: Since their first demonstration in 2012, TENGs have been extensively studied for various applications, including self-powered sensing, ocean wave energy harvesting, and IoT devices. TENGs are low-cost, lightweight, miniaturized, and easy to integrate, and show high mechanical-to-electrical conversion rates and record power densities, making them suitable for powering various electronic devices and sensors.

However, TENGs have exhibited high output impedance (in the range of MΩ), due to the inherent capacitive structure, leading to a low-energy supply efficiency when the TENG is directly connected to an external load, either to power general electronics or charging energy storage devices with low impedance. Low durability and material degradation are other problems.

To enhance TENG performance, researchers focus on material selection, device design, and operational modes. Low-dimensional carbon materials like carbon nanotubes and graphene, known for their flexibility, high electron mobility, and stability, have shown great potential. For instance, graphene-based TENGs, particularly those using crumpled graphene (CG), have demonstrated significant improvements in output power due to better contact area and surface roughness. Improved triboelectric materials are crucial for optimizing TENG performance.

Reference may be made to the paper ‘Three-dimensional graphene foam based triboelectric nanogenerators for energy systems and autonomous sensors’, Nano Energy, Volume 112, 2023, 108475, ISSN 2211-2855, the contents of which are incorporated to the maximum extent permissible.

### Background to Carbon Foam

One well known example of carbon foam is graphene: graphene, has for many years been of great interest for applications including biosensors, electrochemical sensing systems, supercapacitors, electrodes, and fuel cells. Known methods of producing 3D graphene include the laser induced graphene production described in WO 2019/038558; when a suitable carbon pre-cursor material, such as polyimide film, is positioned on a supporting substrate, and irradiated with a CO₂ laser, then 3D graphene forms at the surface of the exposed polyimide film. Experience has shown that the thickness of the 3D graphene produced by this method is less than 50 μm; further, the 3D graphene itself can be brittle and adhere poorly to an underlying substrate and may flake off that substrate. It is hence unsuited to many applications. Whilst there has been some speculation that graphene could be used as part of a heater for a vaping device, the traditional methods of manufacturing graphene (e.g. chemical vapour deposition) make large scale use of graphene for this purpose uneconomic.

A note on terminology used in the carbon nanostructure field: if we just take the term ‘graphene’, there are many different forms of ‘graphene’; for example, the literature describes monolayer graphene, bilayer graphene, turbostratic graphene, graphene superlattices, graphene fiber, 3D graphene, graphene aerogel, crumpled graphene, and many other forms. This presents a definitional challenge because use of a specific term (e.g., ‘3D graphene’) might imply a limitation to only that specific form of graphene. Further, The IUPAC (International Union for Pure and Applied Chemistry) recommends use of the name “graphite” for the three-dimensional material, and “graphene” only when the reactions, structural relations or other properties of individual layers are discussed.

In this specification, we therefore use the term ‘carbon foam’ as a generalised term, and this term should be expansively construed to cover any carbon nanostructure, such as 3D carbon material foam, including turbostratic twisted multilayer 3D carbon material foam. It may refer to a non-graphene material.

One instance of the term ‘carbon foam’ refers to a material that is manufactured using the methods described in this specification; this material has properties that are somewhat distinct from conventional graphene or conventional graphene foam. For example, graphene foam has several characteristics: it is hydrophobic, with low wettability. Raman analysis of a typical graphene foam reveals the following signatures: absence of a D peak; the 2D peak is higher than the G peak; the peak D: peak G ratio is close to zero. As we will describe in more detail below, the carbon foam generated in an implementation of this invention shares none of these characteristics; it is hydrophilic, with a contact angle below 20°; it lacks the tell-tale Raman signature of graphene: it shows a significant D peak; the 2D peak is significantly less than the G peak; the peak D: peak G ratio is significantly above zero. The term ‘carbon foam’ hence also includes within its scope materials that are carbonaceous nanostructures, such as carbon nano-onion, carbon nano-horn, carbon nano-tubes, carbon nano-dots, nanodiamonds and fullerene, or combinations of any of these.

### SUMMARY OF THE INVENTION

One aspect of the invention is a method of manufacturing an active layer for a triboelectric nanogenerator (TENG), comprising the steps of:
(a) using a first laser beam to irradiate an encapsulated, sub-surface region of a carbon pre-cursor material below a surface of the carbon pre-cursor material, to create carbon foam in that encapsulated, sub-surface region, and then
(b) using a second laser beam (i) to remove or ablate material sitting above the carbon foam, and (ii) to expose the carbon foam and thereby produce a resultant carbon foam material;
(c) using the resultant carbon foam material as an active layer, such as the electropositive layer, in the triboelectric nanogenerator.

We will refer to this as a Dual Laser process.

Optional features of an implementation include any one or more of the following:

The resultant carbon foam material can be used to form an electropositive, tribopositive or charge collecting active layer in the TENG in combination with an electronegative or charge generating material in the TENG, such as made from an organic material (e.g., Teflon, PVC, PDMS, PI, PET).

The carbon pre-cursor may also form the electronegative active layer in the TENG; for example, the carbon pre-cursor material can be a polyimide film and then polyimide film also forms the electronegative active layer in the TENG.

A broad range of materials can be used as the carbon pre-cursor; for example, it can be any of the following: a thermo-setting material, a non-thermo-plastic material, a polyimide film, a polymer, polyimides (for example, poly(4,4′-oxydiphenylene-pyromellitimide), otherwise known as polyimide), polyetherimides (PEI), poly(methyl methacrylate) (PMMA) (e.g., spray-coated PMMA), polyurethanes (PU), polyesters, vinyl polymers, carbonized polymers, photoresist polymers, alkyds, urea-formaldehyde, poly(amic acids) (for example an aryl-containing poly (amic acid)) (for example poly(pyromellitic dianhydride-co-4,4′-oxydianiline), amic acid—otherwise known as polyamic acid); dianhydrides (for example aryl dianhydrides) (for example pyromellitic dianhydride); derivatives of said poly(amic acids); derivatives of said dianhydrides (e.g., derivates of pyromellitic dianhydride), aromatic materials (e.g., aromatic polymers); heteroaromatic materials (e.g., heteroaromatic polymers); polymers containing aromatic moieties; cyclic materials (e.g., polymers containing cyclic moieties); heterocyclic materials (e.g., polymers containing heterocyclic moieties); heteroaromatic materials (e.g., polymers containing heteroaromatic moieties), material including one or more of aromatic bonds, or heteroaromatic bonds or hetero bonds (e.g., imide bonds).

The resultant carbon foam material can be functionalised and/or doped to increase its surface charge density.

A hydrogel electrolyte can be used to separate the resultant carbon foam material electropositive layer, from the electronegative layer.

The second laser beam may alter or transform at least some of the carbon foam generated by the first laser beam, to produce the resultant carbon foam material.

Selecting different laser parameters can lead to a resultant carbon foam with different properties and different morphologies. With the Dual Laser process, these parameters can be varied during testing and development to make different samples of the resultant carbon foam, with the aim of developing a resultant carbon foam with optimal properties and performance for a target TENG application.

Another aspect is a triboelectric nanogenerator (TENG) manufactured using an active layer made using the method define above.

Optional features of an implementation include any one or more of the following:

The active layer comprises carbon foam material that is a non-graphene turbostratic multilayer foam.

The TENG can be integrated with a capacitor whose electrodes are made of the resultant carbon foam material. The TENG and a capacitor can be formed on the same flexible polymer substrate. The TENG can also be integrated with a rechargeable battery.

The TENG can be configured to output a signal that measures one or more of: pressure, shear, stretch, bend, or twist. For example, the resultant carbon foam material is deformable under pressure to enable pressure dependent energy generation by the TENG. The TENG can form a self-powered autonomous pressure sensor e.g. for anonymous room occupancy.

The TENG can be configured to operate as an energy harvester. The TENG may also be configured as the power source for an IOT device. The TENG may be integrated into a floor mat that generates power when a person walks on the floor mat and can also be integrated into a wearable device, or into a seat and is then configured to output a signal when a person sits on the seat.

The TENG can also be configured to output a signal that measures presence of a chemical or gas.

The TENG may be combined with a supercapacitor configured for generating burst power sufficient for wireless data transmission, and the electrodes of the supercapacitor may also also made from the same resultant carbon foam material.

One example of the TENG has at least 95% output power retention over 15 k cycles and has a maximum output power of at least 10 W/m², using an external load resistance of 40 MOhms, and a triboelectric charge density of at least 1 mC/m² and a triboelectric response that shows maximum open-circuit voltage (Voc) and short-circuit current (Isc) of 400 V and 105.7 mA respectively when stimulated at 3 Hz (contact-separation frequency) and 70 mm (optimum gap distance).

Further aspects and features of the invention are defined in the Claims.

### BRIEF DESCRIPTION OF THE FIGURES

The invention will be described with reference to implementations of the invention shown in the following Figures. Note that the resultant carbon foam may be referred to as ‘Gii carbon foam’, where Gii is a registered trademark. The TENG that incorporate Gii carbon foam as an active layer may be referred to as a ‘Gii-TENG.’

FIGS. 1-6 schematically show the ‘Dual Laser’ process used to create the resultant carbon foam when a polyimide (PI) film, acting as the carbon pre-cursor, is positioned on a substrate.

FIG. 7 is a scanning electron image showing the unique morphology of the resultant carbon foam achieved using the Dual Laser method (×250).

FIG. 8 is a scanning electron image showing the surface of conventional laser induced graphene.

FIGS. 9-14B schematically show the Dual Laser process used to create the resultant carbon foam when a PI film, acting as the carbon pre-cursor, is not positioned on a substrate.

FIGS. 15A and B are Raman analyses of the resultant carbon foam sample made by the Dual Laser process.

FIG. 15C is a Raman analysis of carbon nano-onion material.

FIG. 16A are scanning electron images showing the resultant Dual Laser carbon foam and conventional graphene.

FIG. 16B are further scanning electron images showing the resultant Dual Laser carbon foam.

FIG. 17 is a schematic of a high-speed reel to reel or reel to sheet manufacturing system for the resultant carbon foam.

FIG. 18 shows the Raman shifts for eight sheets of the resultant carbon foam made using the Dual Laser process.

FIG. 19A1-D are schematic images of the resultant carbon foam active layer on a PI substrate, with an ITO electronegative active layer.

FIG. 20 is a schematic showing the working principle of a TENG.

FIG. 21 is a schematic showing the automatic actuation setup built to characterise Gii-TENG devices.

FIG. 22A-H depict performance characteristics of the Gii-Teng device.

FIG. 23A-F show characterisation graphs of the Gii-TENG device.

FIG. 24A-D show characterisation graphs of the Gii-TENG device.

FIG. 25A-D shows a self-powered pressure mat using Gii-TENG and performance graphs FIG. 26 is a table including a review of the performance of various carbon based TENGs, including Gii carbon foam.

### INDEX TO FIGURES

### Dual Laser Process

110 IR laser
120 IR laser beam
130 interior of PI film
140 PI film
150 substrate
160 sub-surface carbon foam region
170 disorganised, amorphous, non-graphene material below the sub-surface carbon foam region
180 expanded region of disorganised, amorphous, non-graphene material above the sub-surface carbon foam region
185 unique morphology of the exposed resultant carbon foam
200 CO2 laser beam
210 resultant carbon foam with unique morphology

### DETAILED DESCRIPTION

We organise this Detailed Description section as follows:
SECTION A: MANUFACTURING CARBON FOAM
SECTION B: KEY FEATURES A-K OF THE CARBON FOAM MANUFACTURING PROCESS
SECTION C: CARBON FOAM USED IN TENG DEVICES

In this Section A, we explain how the resultant carbon foam used as the active layer in a TENG (and related carbon foams) may be manufactured. Reference may be made to WO 2023/118866, the contents of which are incorporated to the maximum extent permissible. One implementation of this carbon foam is called Gii® carbon foam.

### Section A: Manufacturing Carbon Foam

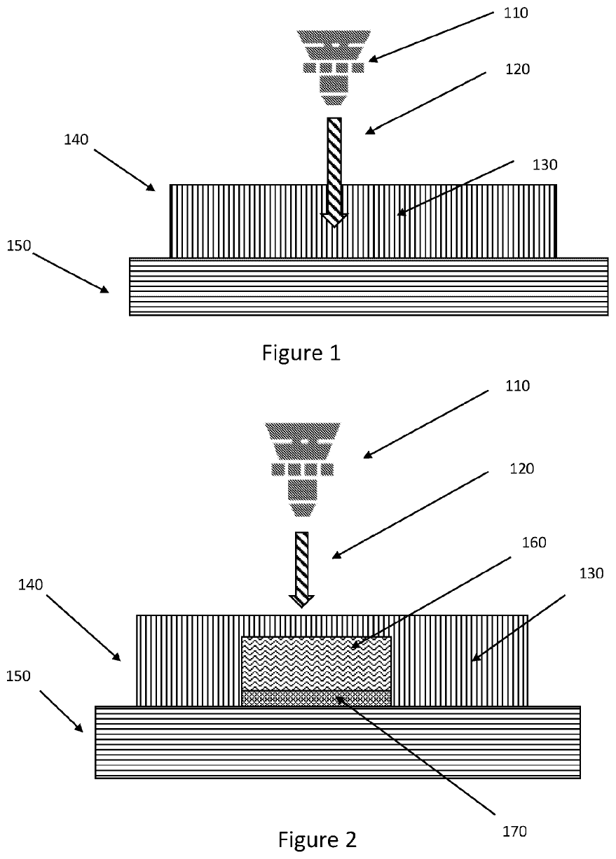

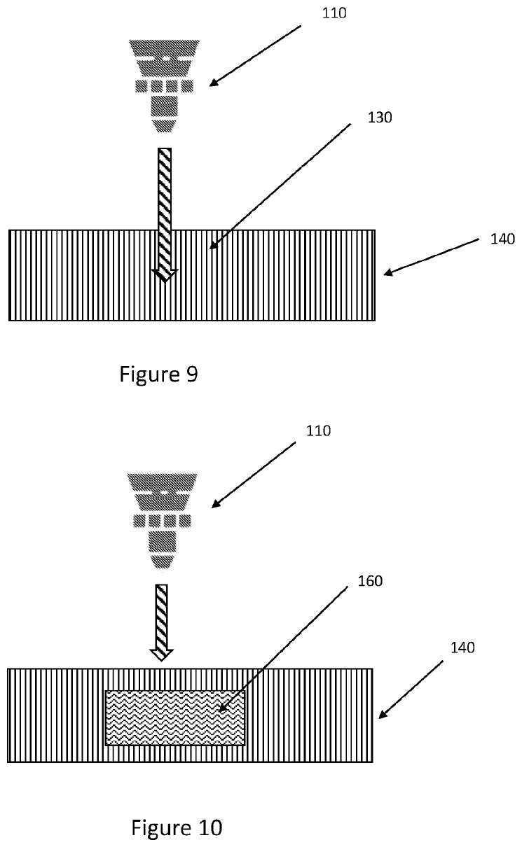

We will start with a simplified, schematic walk-through of implementations of the invention. We give two walk-throughs; the first (FIGS. 1-6) will describe at a high level the carbon foam production process when the carbon pre-cursor (e.g. polyimide (PI) film, such as Kapton® film in this case) is mounted on a substrate; the second walk-through (FIGS. 9-14) covers the carbon foam production process when the polyimide film is not mounted on a substrate. In each case, we use a Dual Laser process; we will explain what the term means below.

In the first stage, (see FIG. 1), laser 110 with wavelength A irradiates with laser beam 120 the interior 130 of polyimide film 140, positioned on a substrate 150 suitable for the end application—in this case, the creation of a carbon foam based active layer in a TENG. This laser can be a pulsed IR laser that delivers IR radiation with a 1064 nm wavelength.

As shown in FIG. 2, the laser 110 with wavelength A is tuned so that a sub-surface region 160 is converted to carbon foam. The focus of laser A moves progressively through the interior 130 of the polyimide film 140 to create the entire carbon foam region 160. The carbon foam region 160 can be approximately 50 μm or greater in depth or height-far taller than is possible with other methods. Note that there is no carbon foam created on the exposed surface (i.e. the surface that the laser beam is incident on) of the polyimide film 140 at any time. The region above the carbon foam 160 (i.e. closer to the laser than the carbon foam region 160) is not converted to carbon foam. The region 170 below the carbon foam region 160 (i.e. the lower surface of the PI film) is also not converted to carbon foam but is instead converted to a disorganised, amorphous non-graphene material that adheres to the underlying substrate 150.

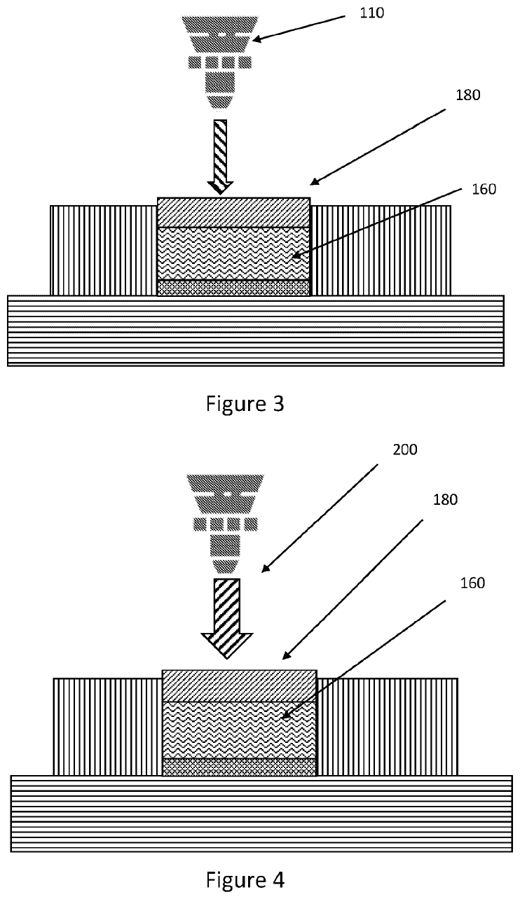

FIG. 3 shows that laser 110 with wavelength A causes a physical expansion at the region 180 above (i.e. closer to the laser than the carbon foam region 160) the internal carbon foam zone 160 due to trapped gasses. This region 180 is not 3D graphene, nor is it a polymer; it is a disorganised, amorphous material.

In a second stage, a laser 200 with wavelength B is now tuned on the disorganised, amorphous material region 180 above the carbon foam region 160, as shown in FIG. 4. This can be a CO₂ laser 200 with a 10.6 μm wavelength.

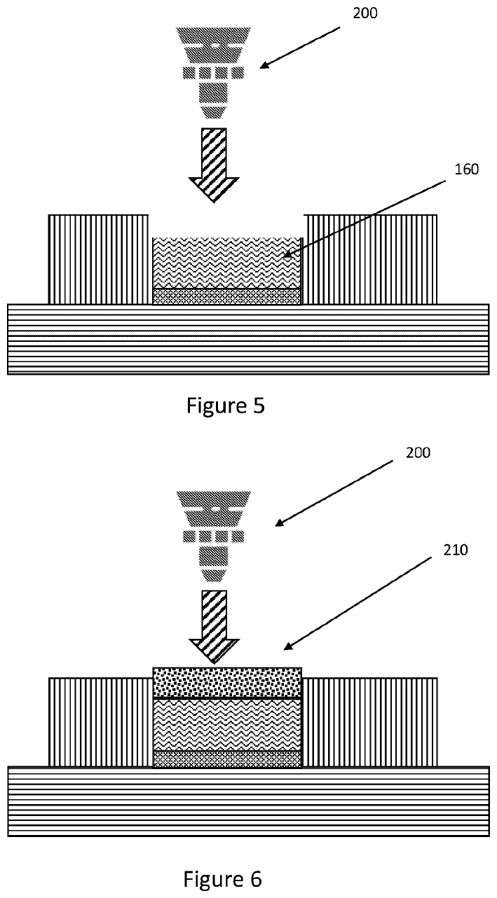

This laser 200 with wavelength B, as shown in FIG. 5, ablates some or all of the region 180 above the carbon foam region160, exposing at least some of the underlying, resultant carbon foam region 160; it may also alter that carbon foam to generate the resultant carbon foam: the laser 200 with wavelength B gives the exposed carbon foam region a unique morphology 210, as shown in FIG. 6, which is a feature of the resultant carbon foam. The term ‘morphology’ includes factors such as pore size and density, defects density, number of carbon layers, and other variables defining the size, shape and structure of the nanostructure.

We refer to the process described in FIGS. 1-6 as a ‘Dual Laser process’.

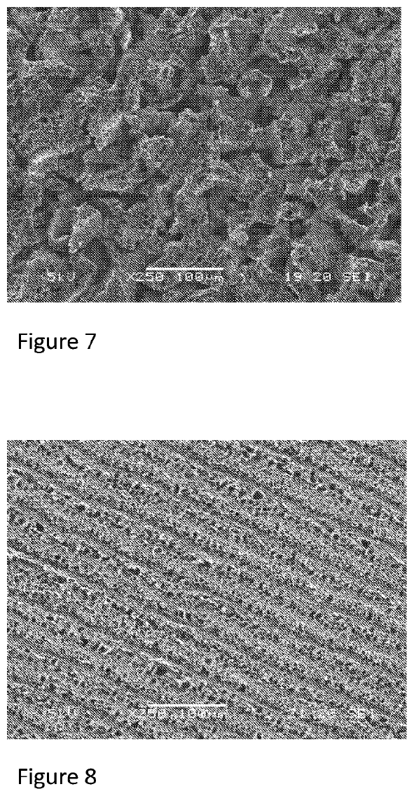

FIG. 7 is a scanning electron image showing the unique morphology achieved using the Dual Laser method (×250). In this case, the carbon source was irradiated first with IR radiation of a wavelength of 1064 nm from a pulsed IR laser, with the radiation focussed into the carbon source and at progressive depths within the carbon source, and then the carbon source was irradiated with a laser beam at wavelength of 10.6 μm from a CO₂ laser. The approximate thickness of the carbon foam layer in this image is 220 μm.

The contrast with the morphology achieved using a conventional LIG (laser induced graphene) method (×250), shown in FIG. 8, is clear: there are clear raster lines, and the folding is less convoluted. The thickness of this layer of carbon foam is less than 50 μm.

From the FIG. 7 images, we may infer that the material created using the Dual Laser process does not have a morphology similar to conventional graphene foam; whilst it appears to be a turbostratic twisted multilayer 3D carbon-based material with a foam like structure, it is not necessarily what one would normally describe as ‘graphene’, in the conventional sense.

In the preceding walk-through (FIGS. 1-6), we looked at the Dual Laser process when the carbon pre-cursor material (the polyimide film) is mounted on a substrate. In the following FIGS. 9-14, we will look at the Dual Laser process when the polyimide film is not mounted on a substrate. The manufacturing processes can use a standard 220 mm×180 mm sheet of polyimide film that is not mounted on a substrate; this size can be accommodated in a standard laser scanning device, of the sort typically used for laser engraving, laser cutting and laser plotting that traces out a path defined by a standard CAD program. The manufacturing processes can also use a standard flatbed screen printing device, and a standard conveyor dryer, again readily compatible with different sizes of thin PI film. Other sizes of polyimide sheet can be accommodated.

As described previously, laser 110 with wavelength A (e.g. IR laser) irradiates the interior 130 of PI film 140; the film 140 is now not mounted on a substrate, as shown in FIG. 9. It can be a sheet that is supported at its edges, or rests temporarily upon a surface, or forms part of a reel of PI film when a continuous manufacturing (e.g. reel to reel or reel to sheet) system is used (see Feature L).

The laser 110 with wavelength A is tuned so that a sub-surface region 160 is converted to carbon foam, as shown in FIG. 10. The focus moves progressively through the film 140 to create the entire carbon foam region 160. The carbon foam region 160 can be approximately 50 μm or greater in height—far deeper or taller than is possible with other methods.

There is no 3D graphene created on the exposed surface of the polymer film at any time. The region above the carbon foam is not converted to 3D graphene.

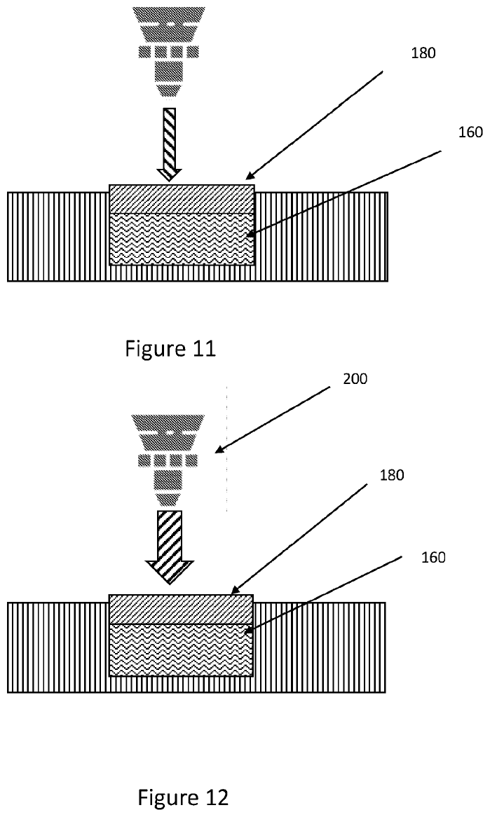

As shown in FIG. 11, there is a physical expansion of the region 180 above the internal carbon foam zone 160 due to trapped gasses. This region is not 3D graphene, nor a polymer; it is a disorganised, amorphous material.

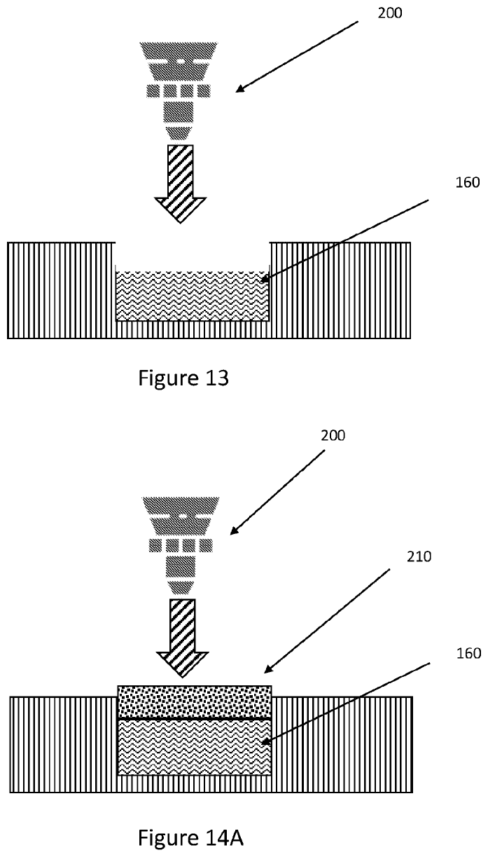

A laser 200 with wavelength B (e.g. CO₂) is now tuned on the region 180 above the carbon foam, as shown in FIG. 12. The laser 200 with wavelength B ablates the region 180 above the carbon foam region 160, exposing at least some of the carbon foam 160, as shown in FIG. 13.

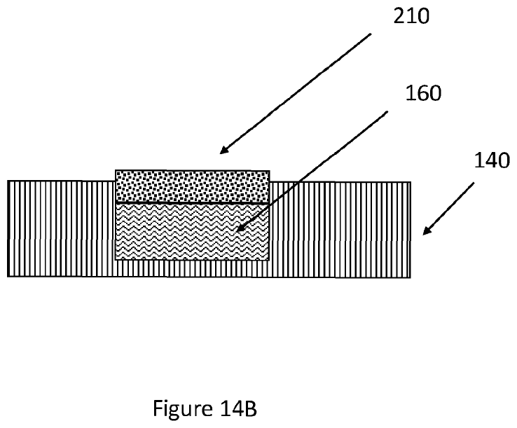

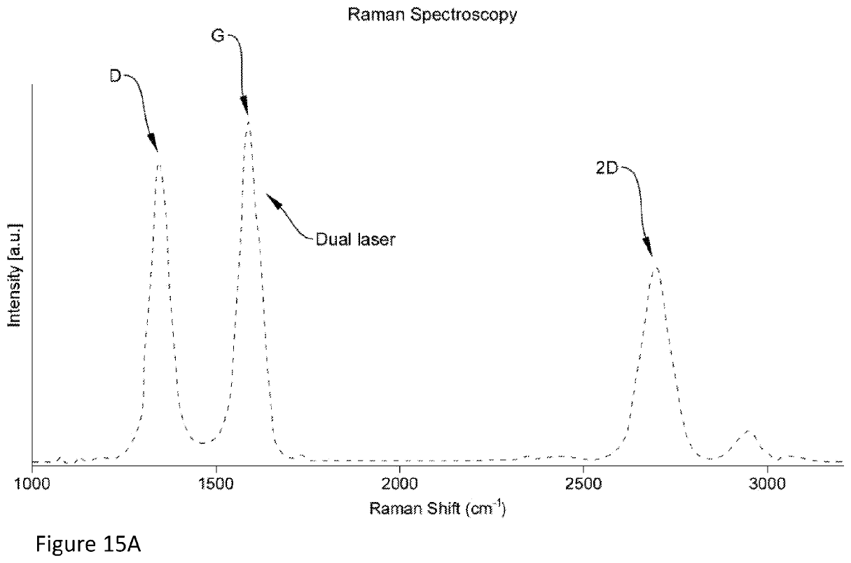

Just as when the polyimide film 140 is mounted on a substrate, the laser 200 with wavelength B can also alter the underlying carbon foam 160 to give the resultant carbon foam a unique morphology 210, as shown in FIG. 14A. As shown in FIG. 14B, the resultant carbon foam possesses this unique morphology, which is important for making this resultant carbon foam an effective active, e.g. electropositive, layer in a TENG.

Some implementation specifics for this Dual Laser approach to carbon foam production now follow: in one example, a Nd:YAG solid state laser is the wavelength A laser and is positioned so that the IR laser radiation beam (wavelength of 1064 nm) produced by the solid-state laser impacts the polyimide layer perpendicular to the layer. Optics focus the IR laser radiation laser beam to a volume of minimum beam convergence within the polyimide layer.

In an encapsulated or sub-surface region or locus around the minimum beam convergence the interaction of the laser light and the polyimide results in carbonization of the carbon source. This carbonization results in the production of carbon foam, such as a twisted or turbostratic multilayer carbon foam, in the encapsulated or sub-surface region and results in the production of a layer of a disorganised, amorphous non-graphene substance at the surface of the polyimide film.

While maintaining the laser beam focused at a particular depth within the polyimide layer, the laser is scanned laterally over the polyimide layer. In this way a path, wholly within the polyimide carbon source, is tracked and is converted to carbon foam. The polyimide is hence carbonized to a carbon foam in a pattern which corresponds to the path tracked by the scanned, focused IR laser beam.

In one set-up, the Nd:YAG IR laser was pulsed at a frequency of 80 kHz and the laser beam was scanned across the surface at a speed of 9.4 cm/s. Other embodiments utilised different parameters. For example, a pulse frequency of 50 kHz and a scan speed of 35.5 cm/s were also utilised to successfully produce carbon foam. The laser power is within a typical working range of 8-20 watts, with 12 W optimum; the laser focal distance is within a typical working range of 50 mm-400 mm.

Once a predetermined area within the polyimide layer has been irradiated in the above manner by the focused IR laser beam, the depth of the encapsulated or sub-surface region or locus in the polyimide is changed and the IR laser beam is again scanned over an area, in this case over the same predetermined area. A standard computer-controlled laser scanning system can be used that controls the X-Y position of a laser over the polyimide film. It may be necessary to pass the focussed IR laser radiation over the same area more than once to produce carbon foam. In this implementation, the focussed IR laser also irradiates adjacent, but not substantially overlapping, areas. This process of irradiating the carbon source with the focussed IR laser radiation at different focus depths is repeated until the desired depth of the polyimide layer has been exposed to the IR laser radiation and carbon foam has been formed in the encapsulated or sub-surface region. The surface layer is however a disorganised, amorphous, non-graphene substance.

In the second step, the polyimide layer is exposed to radiation from a CO₂ laser to perform the ablation step, to expose at least some of the underlying carbon foam, to alter this carbon foam and to give the exposed carbon foam a particular morphology. The radiation from the CO₂ laser is scanned across the surface of the treated carbon source at a speed of 19 cm/s to match the pattern or area which had been irradiated with the IR laser. Other embodiments utilised different parameters. For example, a pulse frequency of 50 KHz and a scan speed of 35.5 cm/s were also utilised to successfully reveal the underlying carbon foam. The laser power is within a typical working range of 8-20 watts, with 12 W optimum; the laser focal distance is within a typical working range of 50 mm-400 mm.

As noted above, the CO₂ laser ablates the surface layer disorganised, amorphous, non-graphene substance, exposing the underlying carbon foam and altering the morphology of that carbon foam to generate an exposed, resultant carbon foam with a greater number of defects compared to standard laser induced graphene; this gives the carbon foam exceptionally useful properties that are superior to standard laser induced graphene, as noted earlier.

Varying the laser parameters for either or both of the lasers (e.g. IR and the CO2 lasers), such as power, focus, wavelength, scanning speed, varies the carbon foam material properties, enabling carbon foam to be produced with properties that are optimised for different applications, such as the electropositive layer in a TENG.

One useful property of the exposed carbon foam made by the Dual Laser process is a high degree of wettability: the contact angle can be less than 20°, making this carbon foam hydrophilic, in contrast with conventional graphene foam, which has a contact angle between 70° and 150°, making it hydrophobic.

Another useful property of the exposed carbon foam made by the Dual Laser process is a high degree of antifouling: the carbon foam could be useful in applications where the build-up of contaminants or residues can harm the performance or lifetime of an element.

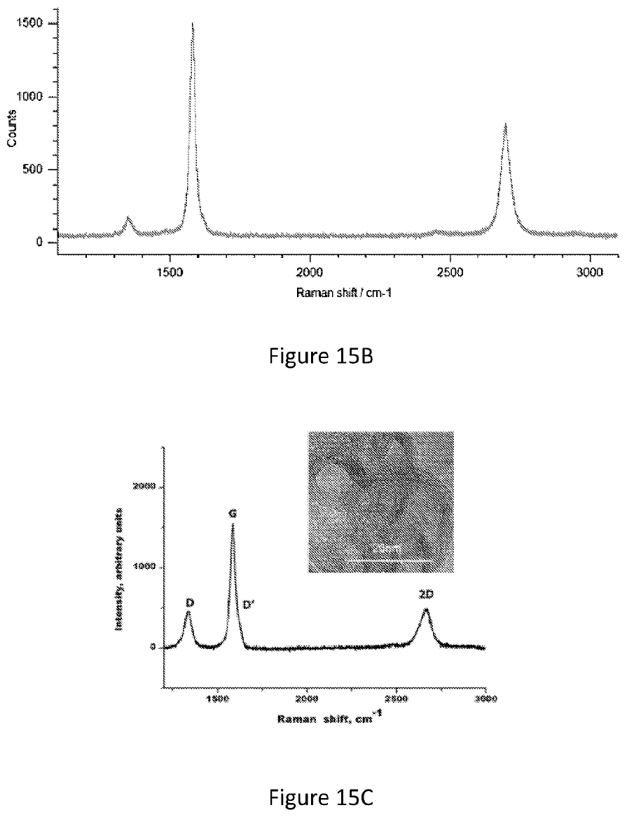

The Raman spectrum of carbon foam made by the Dual Laser process is shown in FIG. 15A has three principal peaks. In particular, the D peak at around 1344 cm⁻¹ is characteristic of the presence of lattice defects and the G peak at around 1577 cm⁻¹ is characteristic of sp² carbon hybridisation, with the presence of distorted six-fold carbon rings. The 2D peak at around 2685 cm⁻¹ is characteristic of second order transitions in the 3D graphene and the absence of a doublet structure here indicates a lack of planar AB stacking which would be found in multilayer 2D graphene or graphite. Fitting the 2D peak with a single Lorentzian peak (having a full width at half maximum of 67 cm⁻¹) centred at 2685 cm⁻¹ indicates that there are only one, or a few, carbon-foam-like layers present in the 3D carbon formed with the two methods. Analysis of the D/G peak ratio (0.85) for the Dual Laser process, indicates a higher defect density compared to a conventional laser-induced graphene process (0.67) that uses a single laser step, as shown in Table 1 below: this high defect density gives the resultant carbon foam properties that make it very suitable as an electropositive layer in a TENG.

TABLE 1

| Process | D/G | 2D/G | D/D′ |
|---|---|---|---|
| Dual Laser | 0.85 ± 0.1 | 0.95 ± 0.12 | 3.7 ± 1.3 |
| Conventional single laser | 0.67 ± 0.13 | 0.75 ± 0.05 | 2.6 ± 0.22 |

As we noted earlier, Raman analysis of a typical graphene foam reveals the following signatures: absence of a D peak; the 2D peak is higher than the G peak; the peak D: peak G ratio is close to zero. The carbon foam generated in an implementation of the invention shares none of these characteristics; it is highly hydrophilic, with a contact angle below 20°; it lacks the tell-tale Raman signature of graphene: FIG. 15A shows, for the material made by the Dual Laser process: presence of a D peak; the 2D peak is lower than the G peak; the peak D: peak G ratio is above zero. FIG. 15B is another Raman analysis of a carbon foam made by the Dual Laser process, again showing the presence of a D peak; the 2D peak is lower than the G peak; the peak D: peak G ratio is above zero. FIG. 15C is a Raman analysis of carbon nano-onion material, see ‘Raman spectroscopy of polyhedral carbon nano-onions’. DOI: 10.1007/s00339-015-9315-9, and the similarities with the Raman for the carbon foam made by the Dual Laser process is apparent. One reasonable interpretation is that the carbon foam that can be made by the Dual Laser process is or includes carbon nano-onion material. Note however that selecting different laser parameters can lead to a resultant carbon foam with different properties and different morphologies. With the Dual Laser process, these parameters can be varied during testing and development to make different samples of the resultant carbon foam, with the aim of developing a resultant carbon foam with optimal properties and performance for a target TENG application.

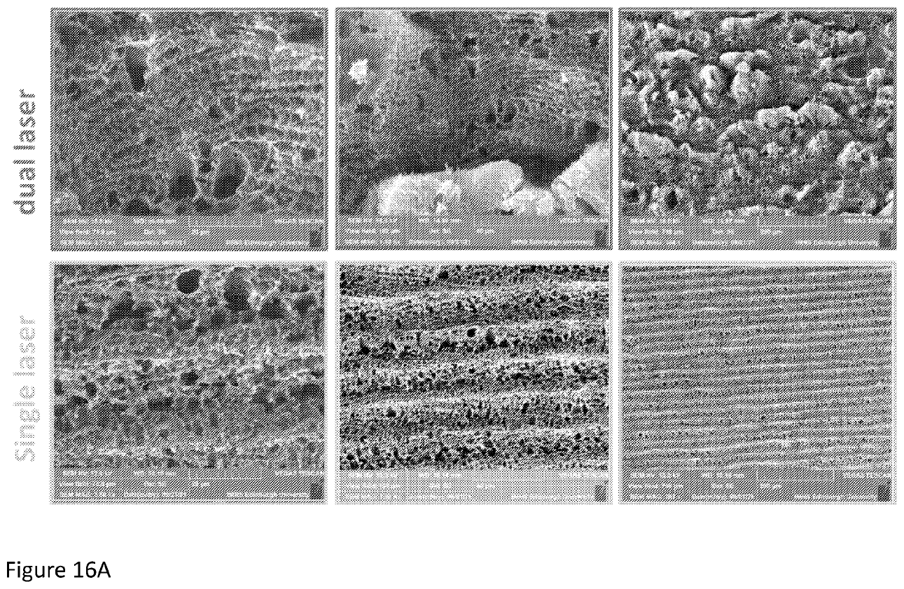

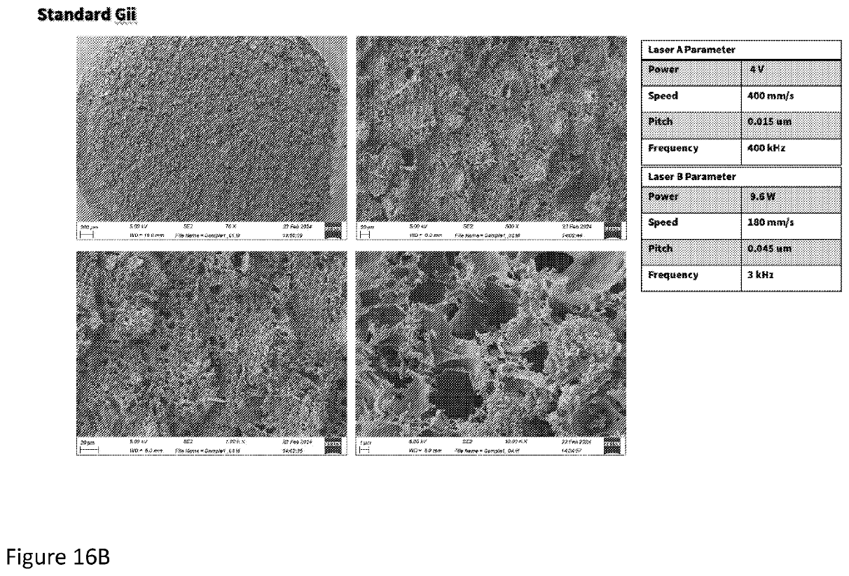

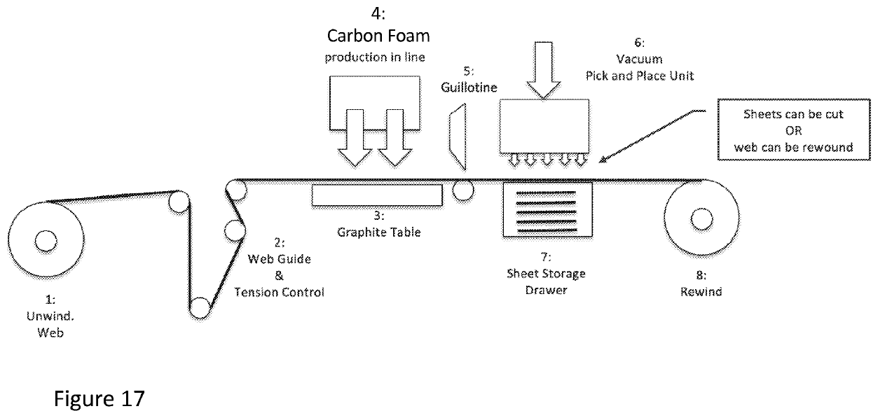

Both the Dual Laser carbon foam and a conventional graphene made by a single laser process show a microporous structure, as shown in the FIG. 16A SEM images. Low magnification images show distinct differences in the surface morphology. The single laser surface shows a smoother, striated surface with rough edges and the carbon foam made by the Dual Laser process shows a rough surface. FIG. 16B are further SEM images showing the resultant Dual Laser carbon foam.

### Section B: Key Features of the Carbon Foam Manufacturing Process

In this section, we outline key Features A-L of an implementation of this invention. These features define the production of the carbon foam used as the active layer in a TENG. One set of features includes the Dual Laser manufacturing process described earlier; this Dual Laser process has many advantages over conventional CVD: we can compare the production of 1 cm² of approximately 50 μm thick carbon foam onto a plastic substrate (or indeed many other types of substrates) in Table 2:

TABLE 2

| | Number of | | | | |
|---|---|---|---|---|---|
| Process | Steps | Time | Temp | Pressure | Cost |
| CVD | 6 | 300 mins | 800 C | Vacuum | $50 |
| Dual Laser | 1 | 2 mins | 20 C | Ambient | sub $1 |
| Process | | | | | |

Features A-L define various aspects of a carbon foam manufacturing process that is highly scalable, high yield, highly reproducible and that can be easily adapted to many different applications that all use the same process.

The Dual Laser carbon foam has the following advantages over conventional graphene foam: larger surface area; more porous structure; higher quality; lower sheet resistance; higher wettability; higher anti-fouling.

The Features A-L are organised into the following four groups:
Group 1: Sub-surface carbon foam
Group 2: Dual laser processing
Group 3: Miscellaneous

We can expand on this organisation as follows:

### Group 1: Sub-Surface Carbon Foam

Feature A: Carbon foam created in a sub-surface region of a carbon pre-cursor material
Feature B: Carbon foam created in an encapsulated region of a carbon pre-cursor material
Feature C: Carbon foam created in a region of a carbon pre-cursor material, where the region has no substantial gas escape pathways
Feature D: Amorphous, non-graphene material adhering to the substrate

### Group 2: Dual Laser Processing

Feature E: Carbon foam created by laser ablating a sub-surface carbon foam region
Feature F: Non-graphene carbon foam created by laser ablating a sub-surface carbon foam region
Feature G: Dual lasers operating at different frequency bands
Feature H: Electrical contacts positioned in carbon foam created by laser ablating a sub-surface carbon foam region
Feature I: Printing electrical contacts on the polyimide film and then creating the exposed carbon foam
Feature J: Tall tracks made in the carbon foam
Feature K: Applying the first and second lasers in different manufacturing facilities

### Group 3: Miscellaneous

Feature L: Scalable manufacturing of carbon foam: Gii 3

Turning now to Group 1:
Group 1: Sub-surface carbon foam
Feature A: Carbon foam created in a sub-surface region of a carbon pre-cursor material

Earlier, prior art approaches to laser induced graphene convert a surface layer of a carbon pre-cursor to 3D graphene. The resultant 3D graphene can however be somewhat brittle, may flake off from the underlying substrate and be generally unsuited to many real-world applications; further, the 3D graphene is typically relatively thin, with a depth of less than 50 μm.

In this specification, we describe an alternative approach in which the surface of the carbon pre-cursor is not converted to graphene at all; instead, it is only a sub-surface region of the carbon pre-cursor 140 that is converted to a carbon foam 160 by a focussed laser beam 110; in one implementation, a focussed IR beam 110 generates a temperature higher than 500 °C at the sub-surface or encapsulated region inside a polyimide film 140 over a very short time, between 1 ns and 10 μs (i.e. at a rate of between around 5×10⁷ °C/s and 2×10¹² °C/s); this brief, intense heating is sufficient to form carbon foam 160 in this sub-surface or encapsulated region. There are no substantial gas escape paths from this sub-surface or encapsulated region 160; constraining the gaseous products to within the sub-surface or encapsulated region beneficially affects the structure of the carbon foam 160 formed in that sub-surface region. Formation of carbon foam 160 solely in a sub-surface region was an unexpected discovery; it was unexpected for several reasons, including a very low absorbance (absorbance of radiation per cm (base 10) of sub 50 or as low as sub 10 of the 1064 nm IR radiation by the polyimide carbon pre-cursor material.

The surface (e.g., the interface between the carbon pre-cursor material perpendicular and facing towards the laser and the gaseous environment surrounding the carbon pre-cursor material) expands under laser irradiation and is converted from the carbon pre-cursor material to a disorganised, amorphous, non-graphene substance 180. This disorganised, amorphous, non-graphene substance 180 forms a layer that is typically at least 1% of the total thickness of the carbon pre-cursor material; for a 500 μm thick polyimide film, then typically the top 1 μm-10 μm is converted to the disorganised, amorphous, non-graphene substance 180; below this upper surface layer, in the body of the carbon pre-cursor material, we have the region that is converted to a carbon foam 160.

The thickness of this carbon foam 160 is controlled by moving the focus of the laser beam progressively through the carbon pre-cursor material; unusually thick carbon foams structures can be made using this process: 50 μm-200 μm (approx.) thick carbon foam tracks have been achieved.

If the laser illuminates a carbon film pre-cursor material, such as a polyimide film that is suspended in space as shown in FIGS. 9-14B (i.e., is not mounted on a substrate), then, after irradiation, as we progressively move through the material, we have at the upper surface, i.e., facing the laser, a disorganised, amorphous, non-graphene substance 180; we then have the carbon foam region 160. The laser beam 110 does not generally approach the lower surface of the carbon pre-cursor material, so that the carbon foam region 160 sits over carbon pre-cursor material that has not been converted to a carbon foam. If the laser approaches the lower surface of the carbon pre-cursor material, then the carbon pre-cursor close to and at the lower surface is converted to a disorganised, amorphous, non-graphene substance.

Similarly, if the laser illuminates a carbon pre-cursor film, such as a polyimide (PI) film that is mounted on a substrate, as shown in FIGS. 1-6, then we have the same sequence of materials; in addition, the laser will usually approach the lower surface of the carbon pre-cursor material that lies against the substrate: the carbon pre-cursor close to and at the lower surface is then converted to a disorganised, amorphous, non-graphene substance 170. This disorganised, amorphous, non-graphene substance 170 adheres to the substrate 150; since the carbon foam region 160 is bonded to this disorganised, amorphous, non-graphene substance 170, the result is that the carbon foam region 160 is itself not bonded directly to the substrate 150, but is nevertheless securely attached via the intermediary disorganised, amorphous, non-graphene substance 170 to the substrate 150.

This approach enables carbon foam structures that are significantly thicker than is possible with earlier approaches that limited graphene foam formation to a surface region. Further, this approach enables carbon foam structures that adhere more robustly, although not directly, to an underlying substrate. Note that with this approach, carbon foam is not produced at any surface of the carbon pre-cursor material. Instead, carbon foam is produced solely in a sub-surface region inside the carbon pre-cursor material.

We can generalise to:

A method of manufacturing carbon foam material for an active layer in a triboelectric nanogenerator (TENG), comprising the step of irradiating a sub-surface region of a carbon pre-cursor material, parameters of the laser beam being selected to create a carbon foam in that sub-surface region.

### Feature B: Carbon Foam Created in an Encapsulated Region of a Carbon Pre-Cursor Material

In Feature A above, we defined the region in which the carbon foam is generated by laser irradiation as a ‘sub-surface’ region. Another way of describing the region is to qualify it as ‘encapsulated’; this captures the 3-dimensional relationship of the carbon foam to its surroundings; the carbon foam 160 is ‘encapsulated’ by the original carbon precursor material and by the disorganised, amorphous, non-graphene substance 180 generated by laser irradiation at the upper surface of the carbon pre-cursor material 140.

We can generalise to:

A method of manufacturing carbon foam material for an active layer in a triboelectric nanogenerator (TENG), comprising the step of irradiating an encapsulated region of a carbon pre-cursor material, parameters of the laser beam being selected to create a carbon foam in that encapsulated region.

Feature C: Carbon Foam Created in a Region of a Carbon Pre-Cursor Material, where the Region has No Substantial Gas Escape Pathways

We have seen above that a sub-surface or encapsulated region of the carbon pre-cursor is converted to a carbon foam and there are no substantial gas escape paths from this sub-surface or encapsulated region; constraining the gaseous products to within the sub-surface or encapsulated region affects the structure of the carbon foam 160 formed in that region.

We can generalise to:

A method of manufacturing carbon foam material for an active layer in a triboelectric nanogenerator (TENG), comprising the step of irradiating an encapsulated, sub-surface region of a carbon pre-cursor material, parameters of the laser beam being selected to create a carbon foam in that region and in which no substantial gas escape pathways to a surface of the pre-cursor material are created by the laser beam.

### Feature D: Amorphous, Non-Graphene Material Adhering to the Substrate

We have seen earlier that if the laser 110 illuminates a carbon film 140 that is mounted on a substrate 150, then the laser carbonises the surface of the carbon film adjacent to the substrate 150 to form a disorganised, amorphous, non-graphene substance 170 adjacent to the substrate 150; this disorganised, amorphous, non-graphene substance 170 adheres to the substrate 150; since the internal, or sub-surface or encapsulated carbon foam region 160 is itself bonded to this disorganised, amorphous, non-graphene substance 170, the result is that the carbon foam region 160 is itself not directly attached to the substrate 150, but is nevertheless securely positioned on the substrate 150, via the intermediary disorganised, amorphous, non-graphene substance 170. The carbon foam region 160 is more securely bonded, compared to conventional laser induced graphene, and is less likely to flake off, even where the substrate is flexible, enabling for example biosensor applications where the substrate is often a thin and flexible structure.

We can generalise to:

A method of manufacturing carbon foam material for an active layer in a triboelectric nanogenerator (TENG), comprising the step of irradiating an internal region of a carbon pre-cursor material, positioned on a substrate, parameters of the laser beam being selected to create a carbon foam in that region and to create a disorganised, amorphous, non-graphene material between the carbon foam region and the substrate; in which that disorganised, amorphous, non-graphene material is adhering or otherwise attaching directly to the substrate.

### Group 2: Dual Laser Processing

### Feature E: Carbon Foam Created by Laser Ablating a Sub-Surface Carbon Foam Region

Previous Features A-D have covered the creation of a carbon foam in a sub-surface or encapsulated region of the carbon pre-cursor material. So in Features A-D, we define the operation of the first laser in generating a carbon foam; that carbon foam is then subsequently exposed and/or treated by a second laser to produce the carbon foam material that can be used as an active layer in a triboelectric nanogenerator (TENG). This Feature E defines this Dual Laser processing.

Because the carbon foam is not formed on an exposed surface, and many applications require the carbon foam to be exposed, we can perform an additional step that includes revealing or exposing at least some of the sub-surface or encapsulated carbon foam.

We have seen earlier that the laser irradiation using IR laser 110 forms a disorganised, amorphous, non-graphene material 180 over the sub-surface or encapsulated carbon foam 160: We now use a laser, typically a long IR CO₂ laser 200, to ablate or otherwise treat this disorganised, amorphous, non-graphene material 180 and hence expose the underlying carbon foam 160. This second laser 200 is typically de-focused, unlike the initial laser.

As noted earlier, we use a standard 220 mm×180 mm polyimide sheet (but other sizes of polyimide sheet can be accommodated); this size that can be accommodated in a standard laser scanning device, of the sort typically used for laser engraving, laser cutting and laser plotting that traces out a path defined by a standard CAD program, and also a standard flatbed screen printing device, and a standard conveyor dryer. Other sizes of polyimide sheet can be accommodated.

We have found that this secondary laser irradiation step alters the morphology and other characteristics of the underlying carbon foam in surprising and favourable ways, to generate a twisted or turbostratic multilayer carbon foam not previously observed. Varying the CO₂ laser 200 parameters can alter the carbon foam material properties, enabling carbon foam to be produced with properties that are optimised for different applications.

This newly exposed carbon foam includes one or more of the following properties:
a readily controlled thickness or depth
greater flexibility compared to the highly brittle graphene made using conventional laser processes.
strong adhesion to any underlying flexible substrate
high porosity
high electrical conductivity
increased capacitance or charge storage
rapid absorption of organic solvents and water-based solutions
higher hydrophilicity
high EMI shielding
enhanced electrode quality
high wettability
anti-fouling

Note that it is possible to alter one or more of these properties, as well as the size and extent of defects, and the size (including the relative size) of the Raman D and 2D peaks, by varying the laser parameters of either or both of the laser used in the Dual Laser process. In this way, it is possible to produce a carbon foam with properties tuned or especially suitable for different applications. It was surprising that the operation of the second ablation laser could enable the creation of a useable, exposed carbon foam region, especially one with properties that could be adjusted by varying the parameters of the first and/or second lasers.

We can generalise to:

A method of manufacturing carbon foam material for an active layer in a triboelectric nanogenerator (TENG), comprising the steps of (a) a laser beam irradiating an encapsulated or sub-surface region of a carbon pre-cursor material, to create a carbon foam in that encapsulated or sub-surface region and a disorganised, amorphous non-graphene substance above the carbon foam, and then (b) laser ablation or treatment to remove the disorganised, amorphous non-graphene substance and to expose at least some of the carbon foam.

### Feature F: Carbon Foam Created by Laser Ablating a Sub-Surface Carbon Foam Region

In the preceding Feature E, we described the formation of carbon foam 160 in an encapsulated or sub-surface region of the carbon pre-cursor by irradiating that region with a laser 110 (e.g. an IR laser); that irradiation causes the overlying (in the direction of the laser) carbon pre-cursor material 140 to expand into a disorganised, amorphous, non-graphene substance 180; we then expose or reveal that carbon foam 160 by ablating the overlying disorganised, amorphous, non-graphene substance 180 with a second laser 200, e.g. a CO2 laser. This second irradiation step not only ablates the overlying disorganised, amorphous non-graphene substance 180 and hence exposes the underlying carbon foam 160, but also gives this underlying carbon foam an unexpected and unusual morphology 210 with very desirable characteristics; this resultant carbon foam may be a twisted or turbostratic, multilayer carbon foam.

However, because this foam may have characteristics (such as extensive defects, appearance, wettability and a Raman spectrum which are not associated with a graphene foam, in this Feature F, we explicitly describe this foam as a ‘non-graphene carbon foam’. The term ‘non-graphene carbon foam’ hence (unlike the term ‘carbon foam’) explicitly excludes graphene foams, including twisted or turbostratic multilayer graphene foams, but extends to cover any other 3D carbon material foam.

We can generalise to:

A method of manufacturing non-graphene carbon foam for an active layer in a triboelectric nanogenerator (TENG) comprising the steps of
(a) a laser beam irradiating an encapsulated or sub-surface region of a carbon pre-cursor material to create a carbon foam in that encapsulated or sub-surface region in the carbon pre-cursor material, and a disorganised, amorphous non-graphene substance above the carbon foam and then
(b) laser ablation or treatment to remove the disorganised, amorphous non-graphene substance and expose at least some of the underlying carbon foam and transform at least some of that underlying carbon foam into a non-graphene carbon foam.

### Feature G: Dual Lasers at Different Bands

We have seen in the preceding Features E and F that we may use two separate laser irradiation steps. These are usually carried out using two separate lasers: the first step, that creates the sub-surface or encapsulated carbon foam, is typically done with a focused IR laser 110; and the second step involves laser irradiation at a longer wavelength with a de-focused CO2 laser 200, but other wavelengths (e.g., UV and visible) may also be used.

The second laser 200 ablates the material 180 sitting between the carbon foam 160 and the surface (e.g., a disorganised, amorphous non-graphene material) and exposes the underlying carbon foam 160. The exposed carbon foam 160 may also be altered (e.g., in its morphology 210) by the second laser, i.e. the term ‘exposes’ and ‘to expose’ should be construed broadly to include not just revealing at least some of the underlying, pre-existing carbon foam, but also transforming or altering at least some of the underlying pre-existing carbon foam into a resultant 3D carbon material foam with characteristics that differ from those of pre-existing graphene foam.

We can generalise to:

A method of manufacturing a carbon foam material for an active layer in a triboelectric nanogenerator (TENG) comprising the steps of
(a) using a laser beam operating at a first band to irradiate an encapsulated or sub-surface region of a carbon pre-cursor material below a surface of the material, to create carbon foam in that encapsulated or sub-surface region, and then
(b) using a laser beam operating at a second band to remove or ablate material sitting above the carbon foam, to expose at least some of the carbon foam.

### Feature H: Electrical Contacts Positioned in Carbon Foam Created by Laser Ablating a Sub-Surface Carbon Foam Region

We have seen earlier how we create a resultant carbon foam, which may be a twisted or turbostratic, multilayer carbon foam: because this material has exceptional electrical properties (e.g., conductivity; capacitance), we can attach or locate one or more electrical contacts (including also electrical items such as flexible electronics, microprocessors, antennas, IoT devices, electrical interfaces) into the carbon foam. For printed tracks (e.g. screen printed silver tracks), these are screen printed onto the polyimide film (or other suitable substrate) and over and into the pre-existing 3D carbon material foam, so that the tracks make good electrical contact with the foam, and any structures formed on the foam. For an active layer in a TENG, as made up of the resultant carbon foam made using the Dual Laser process, good quality, robust electrical contacts are very important.

We can generalise to:

A method of manufacturing carbon foam material for an active layer in a triboelectric nanogenerator (TENG) comprising the steps of:
(a) using a laser beam operating at a first band to irradiate an encapsulated or sub-surface region of a carbon pre-cursor material below a surface of the material, to create carbon foam in that encapsulated or sub-surface region, and then
(b) using a laser beam operating at a second band to remove or ablate material sitting above the carbon foam, to expose at least some of the carbon foam; and
(c) attaching, printing or locating one or more electrical contacts into the carbon foam.
   Feature I: Printing Electrical Contacts on the Polyimide Film and then Creating the Exposed Carbon Foam

In Feature H, we have seen that once the Dual Laser process is completed, then electrical contacts or circuits are added to contact the pre-existing carbon foam—e.g. simple silver electrical contacts can be screen printed on to the carbon foam. In this Feature I, we describe starting the process by first screen printing the electrical contacts on to the polyimide film, and then finishing the process by creating the exposed carbon foam using the second, laser ablation step of the Dual Laser process. This has some advantages, because the screen printing process can disturb or disrupt the carbon foam. This is a process we call ‘PPC’, an acronym for Post Printing Conversion, in which the screen printing steps are done before the Dual Laser process to create the carbon foam.

So for screen printed tracks (e.g. screen printed silver tracks), these are screen printed onto the polyimide film (or other suitable substrate) in such a way that the carbon foam is subsequently formed around one end of the printed tracks, providing a contact area with a large surface and hence very good electrical connectivity. As with the alternative process described in Feature H above, the printed tracks also make good electrical contact with any structures formed on the foam.

An alternative sequence involves using the first laser beam to create the sub-surface carbon foam, then screen printing the electrical contacts, and then using the second laser beam to create the carbon foam in a way that makes good electrical contact with the electrical contacts.

We can generalise to:

A method of manufacturing carbon foam material for an active layer in a triboelectric nanogenerator (TENG) comprising the steps of:
(a) screen printing electrical contacts onto or into a carbon pre-cursor material;
(b) using a laser beam operating at a first band to irradiate an encapsulated or sub-surface region of a carbon pre-cursor material below a surface of the material, to create carbon foam in that encapsulated or sub-surface region, and where steps (a) and (b) can be performed in the sequence (a) then (b) or (b) then (a); and
(c) using a laser beam operating at a second band to remove or ablate material sitting above the carbon foam, to expose at least some of the carbon foam to which the electrical contacts are connected.

### Feature J: Tall Tracks Made in the Carbon Foam

We have seen earlier that the thickness of the sub-surface or encapsulated carbon foam region can far exceed the thickness of conventional graphene foams that are restricted to a surface layer: the laser focus of the first laser beam can be progressively moved down through the carbon pre-cursor material to create a deep or thick layer of sub-surface or encapsulated carbon foam. We then deploy the second laser irradiation step, ablating the material sitting between the carbon foam and the surface of the carbon pre-cursor material, to expose the carbon foam (noting that the term ‘to expose’ and similar expressions used in this specification includes to alter and transform). The thickness or depth of this now-exposed carbon foam region can be at least 50 μm; carbon foam of 300 μm thickness has been produced. Increased thickness is beneficial because it can result in better electrical conductivity, greater capacitance, and greater mechanical integrity.

We can generalise to:

A method of manufacturing carbon foam material for an active layer in a triboelectric nanogenerator (TENG) comprising the steps:
(a) using a laser beam operating at a first band to irradiate an encapsulated or sub-surface region of a carbon pre-cursor material below a surface of the material, to create carbon foam in that encapsulated or sub-surface region, and then
(b) using a laser beam operating at a second band to remove or ablate material sitting above the carbon foam, to expose at least some of the carbon foam;
and where the carbon foam is at least 50 μm in thickness or depth.

### Feature K: Applying the First and Second Lasers in Different Manufacturing Facilities

The specific properties or structure of the carbon foam that results from the second laser may be considered to be sensitive information because they define features of the final product; it may well be desirable for the first laser beam process to be carried out by a supplier of the carbon foam at that supplier's manufacturing facility, who then supplies that carbon foam to a customer, who in turn carries out the final stage, using the second laser beam, at their own manufacturing facility As we noted earlier, by varying the parameters of the first and also the second laser, it is possible to alter the carbon foam material properties, enabling carbon foam to be produced with properties that are optimised for different applications. Typical parameters that can be altered or tuned in this way include: intensity, wavelength, pulse frequency, pulse duration, pulse profile, scanning speed, focal distance, heat generated at the sub-surface or encapsulated region.

By splitting the manufacturing process in this way, the supplier is insulated from knowledge of the specific manufacturing processes used by a customer as part of the second laser, ablation process (e.g. how they vary the parameters of the second laser beam to give the exposed carbon foam the properties they require); the customer can keep the details of how they produce finished products confidential.

So the manufacturing process is a three-stage process involving the steps: (a) the first laser beam irradiating a sub-surface region of a carbon pre-cursor material at a manufacturing site to produce unfinished carbon foam product; (b) the unfinished carbon foam product being transferred to a customer-controlled manufacturing site; and (c) the laser ablation or treatment taking place at the customer-controlled manufacturing site.

In addition, this approach enables large scale manufacturing (e.g. see Feature L) of the carbon foam produced by just the first laser process, reducing the cost of this material, which can be used across a number of different applications and customers. The more specialised products generated using the second laser beam may well be manufactured at much lower quantities than the carbon foam produced by just the first laser process. So this approach enables more efficient and lower cost manufacturing of the base material, i.e. the carbon foam produced by just the first laser process.

We can generalise to:

A method of manufacturing a carbon foam material for an active layer in a triboelectric nanogenerator (TENG) comprising the steps:
(a) using a laser beam operating at a first band to irradiate an encapsulated or sub-surface region of a carbon pre-cursor material below a surface of the material, to create carbon foam in that encapsulated or sub-surface region, and then
(b) using a laser beam operating at a second band to remove or ablate material sitting above the carbon foam, to expose at least some of the carbon foam;
in which step (a) is performed at one manufacturing facility and step (b) is performed at a different facility.

### Group 3

### Feature L: Scalable High Speed Manufacturing: G-ii 3

Gii-3 is a scalable manufacturing plant with reel-to-reel or reel-to-sheet production of all of the Gii-based materials described above. A key commercially advantage is that Gii 3 manufacturing does not need bespoke equipment—it uses off the shelf computer controlled lasers for the Dual Laser carbon foam manufacturing and conventional screen printing and drying technology: these are well known, well understood manufacturing processing steps and equipment, leading to repeatability and reliability.

We can generalise to:

A method of manufacturing carbon foam material for an active layer in a triboelectric nanogenerator (TENG);
in which the method includes passing a continuous reel of a carbon pre-cursor film through a sequence of operations required to manufacture the carbon foam material made, at least in part, by the method defined in any of Features A-K above.

For Features A-L, the following optional features are especially relevant. Note that any one or more of the following optional features may each be combined with any one or more other, compatible optional features and with any one or more of Features A-L:

We will cover the following areas:
the manufacturing processes
the first laser beam parameters and control scheme
attributes of the sub-surface or encapsulated region
the carbon pre-cursor material
the substrate supporting the carbon pre-cursor material
the carbonisation at the surface that the laser beam is incident on
the ablation laser beam or second laser beam
the carbon foam

Note that any one or more of the following optional features may each be combined with any one or more other, compatible optional features and with any one or more of the other ‘Features’ listed in this specification (e.g., Features A-L).

The laser-based manufacturing process described above has many advantages over a conventional CVD process; we can list these as the following optional features:
is a room temperature process.
is an ambient pressure process.
can be performed on a plastic substrate (compatible with any manufacturing process, not just silicon chip fabrication).
can be done without a catalyst.
takes approximately 2 minutes or less to manufacture 1 cm² of approximately 50 μm thick carbon foam onto a plastic substrate.
enables a 3D carbon foam to be created on a flexible substrate
requires no graphene or graphene oxide precursor.
creates carbon foam material solely in the encapsulated or sub-surface region of the carbon pre-cursor material and not at any surface of the carbon pre-cursor material.
uses a combination of industry standard, low cost and scalable (i) screen printing technology and (ii) computer-controlled laser scanning technology.
can be adapted for high-speed, high volume reel-to-reel or reel-to-sheet production.

The first laser beam parameters and control scheme are important to the production of carbon foam; we define the relevant optional features here:
parameters of the laser beam that irradiates the sub-surface or encapsulated region include one or more of: intensity, wavelength, pulse frequency, pulse duration, pulse profile, scanning speed, focal distance, heat generated at the sub-surface or encapsulated region.
varying the laser parameters alters the carbon foam material properties, enabling carbon foam to be produced with properties that are optimised for different applications.
varying the laser parameters alters one or more of the following carbon foam material properties or parameters: size of defects, distribution of defects, extent of defects, type of defects, of the Raman D and 2D peaks, relative size of the Raman D and 2D peaks, thickness or depth, flexibility, adhesion, porosity, electrical conductivity, capacitance, absorption of organic solvents and water-based solutions, hydrophilicity, EMI shielding, electrode quality, wettability, contact angle, anti-fouling.
laser beam generates a temperature higher than 500 °C in the sub-surface or encapsulated region to form carbon foam.
laser beam generates a temperature of over approximately 500 °C in the sub-surface or encapsulated region to form carbon foam.
laser pulse duration is between approximately 1 ns and 10 μs, giving a heating rate of between around 5×10⁷ °C/s and 2×10¹² °C/s.
laser power is within a typical working range of 8-20 watts, with 12 W optimum.
laser focal distance is within a typical working range of 50 mm-400 mm.
laser pulse frequency is between approximately 50 kHz and 500 kHz.
laser pulse frequency is between approximately 1 kHz and 2 MHz.
laser wavelength is between approximately 0.7 μm-2.5 μm.
laser is scanned at between approximately 9 cm/s and 40 cm/s.
parameters of the laser beam include focus parameters.
parameters of the laser beam include diffraction parameters.
parameters of the laser beam include interference pattern parameters.
focus of the laser beam moves through the depth of the carbon pre-cursor material to generate carbon foam in the sub-surface or encapsulated region of the carbon pre-cursor that the focus passes through.
focus of the laser beam moves at least approximately 50 μm through the depth of the carbon pre-cursor material to generate carbon foam in the sub-surface or encapsulated region of the carbon pre-cursor of at least 50 μm thickness.
focus of the laser beam moves at least approximately 100 μm through the depth of the carbon pre-cursor material to generate carbon foam in the sub-surface or encapsulated region of the carbon pre-cursor of at least 100 μm thickness.
laser beam scans (e.g., raster scans) or moves laterally across the carbon pre-cursor material to form a desired pattern.
laser beam scans or moves laterally across the carbon pre-cursor material to form a desired pattern that includes non-overlapping regions or lines.
laser beam is repeatedly scanned (e.g., raster scanned) or moved laterally across the carbon pre-cursor material with a focus or intensity maximum arranged to multiple different depths within the carbon pre-cursor material until carbon foam of the required pattern and depth has been created.
laser beam is scanned at a scan rate of between 1.7 mm/s and 3550 m/s, or more typically between 35 mm/s and 350 mm/s and the scanning may be such that the number of pulses per inch (PPI) is between 100 and 10000 (relevant to the production of individual approximately polyimide sheets of size 220 mm×180 mm).
laser beam has a wavelength with substantially no absorbance by the carbon pre-cursor material.
laser beam has a wavelength with very low absorbance by the carbon pre-cursor material, where the radiation absorbance per cm (base 10) is below 50, or below 20 or below 10.
laser beam is an IR laser.
laser beam is an IR laser with wavelength of between approximately 0.7 μm-2.5 μm.
laser beam is an IR laser with wavelength of between approximately 0.75 μm-1.40 μm.

The attributes of the sub-surface or encapsulated region in which carbon foam is created can be defined by the following optional features:
unlike conventional graphene foams, the sub-surface or encapsulated region can be over approximately 50 μm in thickness.
a desired depth of the sub-surface or encapsulated region in the carbon pre-cursor material is achieved by moving the focus of the first laser beam through that depth.
the sub-surface or encapsulated region can be at different depths below the surface of the carbon pre-cursor material facing the incident laser; the exact depth at which the sub-surface or encapsulated region is a function of various factors, such as laser intensity, the choice of carbon pre-cursor material used etc. For example, the sub-surface or encapsulated region can be at least approximately 10 μm, 20 μm, 30 μm, 40 μm, 50 μm or more below the surface of the carbon pre-cursor material.
the sub-surface or encapsulated region can have a thickness of between approximately 10 μm and 200 μm.
the sub-surface or encapsulated region is at a distance below the surface of the carbon pre-cursor material that is a function of various factors, such as laser intensity, other laser parameters, the choice of carbon pre-cursor material used etc. For example, the top of the sub-surface or encapsulated region can be below the surface by at least 1%, 10%, 20%, 30%, 40% of the total thickness of the carbon pre-cursor material.
the sub-surface or encapsulated region is a volume of space centred at the mid-point of the minimum cross-section of the first laser beam and the volume is within 500 or 100 microns, or 1 micron of this mid-point.

The carbon pre-cursor material can be defined by the following optional features:
the carbon pre-cursor material is made substantially of thermo-setting material.
the carbon pre-cursor material is made substantially of non-thermo-plastic material.
the carbon pre-cursor material is a thermo-setting film.
the thermo-setting film is a polyimide film.
carbon pre-cursor is a polyimide film.
carbon pre-cursor is a polyimide polyimide film, the wavelength of the first laser is within the range of 0.7 μm to 2.5 μm.
carbon pre-cursor is at least 50% carbon by mass, or at least 75% carbon by mass, or at least 90% carbon by mass.
carbon pre-cursor is a film or sheet.
the carbon pre-cursor material is flexible.
the carbon pre-cursor material is a printed layer, such as a screen-printed layer.
the carbon pre-cursor material has a thickness greater than 5 μm, or between 5 μm and 120 μm, or greater than 120 μm.
the carbon pre-cursor material is substantially planar or flat and is oriented perpendicular to the first laser beam.
the carbon pre-cursor material is homogeneous.
the carbon pre-cursor material is heterogenous and comprises several different materials.
carbon pre-cursor is supported on a substrate that is not made of a carbon pre-cursor.
the absorption coefficient of the carbon pre-cursor material at the first laser beam wavelength is low.
the absorption coefficient of the carbon pre-cursor material for the first laser beam is below 50 cm⁻¹, or below 20 cm⁻¹, or below 10 cm⁻¹
the absorption coefficient of the carbon pre-cursor material for the second or ablation laser beam (see Group 3 Features below) is below 300 cm⁻¹
the absorption coefficient of the carbon pre-cursor material for the second or ablation laser beam is 300±50 cm⁻¹
the carbon pre-cursor material has a thermal conductivity of less than 1.0 W/mK (using a method according to ASTM D5470).
the carbon pre-cursor material has a thermal conductivity of less than 0.5 W/mK (using a method according to ASTM D5470).
carbon pre-cursor material is mounted on a substrate that is substantially optically transparent at the wavelength or wavelengths of the first and/or second laser beams.
the carbon pre-cursor material carbon source comprises or is formed from one or more polymers.
the carbon pre-cursor material comprises one or more of the following materials: polyimides (for example, poly(4,4′-oxydiphenylene-pyromellitimide), otherwise known as polyimide), polyetherimides (PEI), poly(methyl methacrylate) (PMMA) (e.g. spray-coated PMMA), polyurethanes (PU), polyesters, vinyl polymers, carbonized polymers, photoresist polymers, alkyds, urea-formaldehyde.
the carbon pre-cursor comprises one or more of the following materials: poly(amic acids) (for example an aryl-containing poly (amic acid)) (for example poly(pyromellitic dianhydride-co-4,4′-oxydianiline), amic acid—otherwise known as polyamic acid); dianhydrides (for example aryl dianhydrides) (for example pyromellitic dianhydride); derivatives of said poly(amic acids); derivatives of said dianhydrides (e.g., derivates of pyromellitic dianhydride).
the carbon pre-cursor comprises one or more of the following materials: aromatic materials (e.g., aromatic polymers); heteroaromatic materials (e.g., heteroaromatic polymers); polymers containing aromatic moieties; cyclic materials (e.g., polymers containing cyclic moieties); heterocyclic materials (e.g., polymers containing heterocyclic moieties); heteroaromatic materials (e.g., polymers containing heteroaromatic moieties).
the carbon pre-cursor comprises material: containing one or more of aromatic bonds, or heteroaromatic bonds or hetero bonds (e.g., imide bonds).

A substrate can be thought of as a material that presents a surface on which the carbon pre-cursor is positioned; the specific materials, thickness and properties of the substrate are determined by the application: for example, for some sensors, the substrate could be a thin flexible plastic membrane; for other applications, the substrate could be a rigid polyimide board on which electronic circuitry can be mounted. The IR laser can irradiate the carbon source directly; alternatively, radiation from the IR laser may first pass through a substrate before reaching the carbon source, in which case there are two alternative scenarios: first, the substrate is substantially transparent to the IR radiation and the mechanism of carbon foam formation is as described above. But in a second scenario, the substrate is substantially non-transparent to the IR radiation: then, rapid thermal transfer from the substrate into the carbon pre-cursor material first produces a disorganised, amorphous non-graphene layer at the interface layer with the substrate, and carbon foam is then formed in a sub-surface or encapsulated region inside the carbon pre-cursor material.

The substrate on which the carbon pre-cursor material may be positioned and supported can be defined by the following optional features:
the substrate is a plastic body, film, or foil.
the substrate is flexible.
the substrate is a polyimide circuit board.
the substrate has very low absorbance of the first laser beam.
the substrate is substantially optically transparent at the wavelength or wavelengths of the first laser beam.
the substrate has a high absorbance of the first laser beam, absorbing greater than 60% of the first laser beam
the substrate has a high absorbance of the first laser beam, absorbing greater than 60% of the first laser beam and has a thermal conductivity of at least 10 W/mK.
the surface of the carbon pre-cursor material is converted to a disorganised, amorphous, non-graphene substance by the laser beam and that disorganised, amorphous, non-graphene substance adheres or bonds to the substrate and hence indirectly attaches the 3D carbon material foam to the substrate.
the substrate is formed from one or more of the following: silicon (Si), silicon dioxide (SiO2), gallium nitride (GaN), gallium arsenide (GaAs), zinc oxide (ZnO).
the substrate is silicon wafer.
the substrate is a silicon dioxide wafer.
the substrate is a wafer comprising both silicon and silicon dioxide.
the substrate is a carbon source.
the substrate is not a carbon source, e.g. is a metal, dielectric material, a screen-printed dielectric material.
the carbon pre-cursor is positioned ‘above’ the substrate (e.g. the carbon pre-cursor is positioned closer to the laser sources than the substrate).
the carbon pre-cursor is positioned ‘below’ the substrate (e.g. the carbon pre-cursor is positioned further from the laser sources than the substrate).

The carbonisation at the surface that the laser beam is incident on can be defined by the following optional features:
the surface of the carbon pre-cursor material is converted to a disorganised, amorphous, non-graphene substance by the first laser beam.
the disorganised, amorphous, non-graphene substance occupies a thickness below the surface of the adjacent carbon pre-cursor material that is approximately 1%, or less than approximately 1%, or less than approximately 5%, or less than approximately 10%, of the total thickness of the carbon pre-cursor material.
the disorganised, amorphous, non-graphene substance extends to a distance below the surface of the carbon pre-cursor material that is at least 10 μm.
the disorganised, amorphous, non-graphene substance extends from the outer surface into the body of the carbon pre-cursor material to a depth of 10 μm or less, or to a depth of 20 μm or less, or to a depth of 30 μm or less, or to a depth of 40 μm or less, or to a depth of 50 μm or less, or to a depth of 100 μm or less.

The ablation laser beam or second laser beam can be defined by the following optional features:
parameters of the laser beam include one or more of: intensity, wavelength, pulse duration, pulse profile, scanning speed, heat generated at the sub-surface or encapsulated region.
varying the laser parameters alters the carbon foam material properties, enabling carbon foam to be produced with properties that are optimised for different applications.
varying the laser parameters alters one or more of the following carbon foam material properties or parameters: type of carbon nanostructures present (e.g. carbon nano-onion etc), size of defects, distribution of defects, extent of defects, type of defects, of the Raman D and 2D peaks, relative size of the Raman D and 2D peaks, thickness or depth, flexibility, adhesion, porosity, electrical conductivity, capacitance, absorption of organic solvents and water-based solutions, hydrophilicity, EMI shielding, electrode quality, wettability, contact angle, anti-fouling.
laser beam that ablates the amorphous, non-graphene substance that is formed above the encapsulated or sub-surface region in the carbon pre-cursor (the ‘second laser beam’) is a CO2 laser.
the second laser beam alters or transforms the carbon foam as part of the process of exposing it.
the second laser beam alters the morphology of the carbon foam as part of the process of exposing it.
The second laser beam is automatically controlled to be scanned (e.g., raster scanned) across the same regions, and/or overlapping regions and/or non-overlapping regions.
wavelength of the laser beam that ablates the amorphous, non-graphene substance is between 8 μm-15 μm.
the second laser beam is a long IR laser, or a UV laser or a visible light laser.
the second laser beam has a pulse frequency of between 50 kHz and 500 kHz and a scan speed of between 9 cm/s and 40 cm/s.
the absorption coefficient of the carbon pre-cursor material is above 100 cm⁻¹ for the second laser beam, or above 200 cm⁻¹ for the second laser beam.
the absorption coefficient of the carbon pre-cursor material is 300-50 cm⁻¹ for the second laser beam.
laser power is within a typical working range of 8-20 watts, with 12 W optimum.
laser focal distance is within a typical working range of 50 mm-400 mm.
the second laser beam is scanned in a pattern that includes non-overlapping regions or lines.
the second laser beam is scanned in a pattern that matches the scan pattern of the first laser beam.
the second laser beam is de-focussed.
the manufacturing process is a three-stage process involving the steps: (a) the first laser beam irradiating a sub-surface region of a carbon pre-cursor material at a manufacturing site to produce unfinished carbon foam product; (b) the unfinished carbon foam product being transferred to a customer-controlled manufacturing site; and (c) the laser ablation or treatment taking place at the customer-controlled manufacturing site.

The resultant carbon foam can be defined by the following optional features:
the carbon foam is at least 50 μm in thickness.
the carbon foam is between 50 μm to 300 μm in thickness.
the carbon foam is or includes a twisted or turbostratic multilayer foam.
the carbon foam is or includes a carbon foam with a spatial distribution of defects leading to high electrochemical reactivity.
the carbon foam is or includes a carbon foam with vacancy position basal plane defects leading to high electrochemical reactivity.
the carbon foam has a Carbon:Oxygen ratio of between 25:1 and 50:1.
the carbon foam has a fast electron transfer constant.
the carbon foam has one or more of the following properties
   a readily controlled thickness or depth
   greater flexibility compared to the highly brittle graphene made using conventional laser processes.
   strong adhesion to an underlying flexible substrate high porosity
   high electrical conductivity
   increased capacitance or charge storage
   rapid absorption of organic solvents and water-based solutions
   higher hydrophilicity
   high EMI shielding
   enhanced electrode quality
   a contact angle of approximately 20° or less
the properties of the carbon foam are selected by choosing specific laser parameters to generate carbon foam material with one or more of the following desired properties or parameters: size of defects, distribution of defects, extent of defects, type of defects, of the Raman D and 2D peaks, relative size of the Raman D and 2D peaks, thickness or depth, flexibility, adhesion, porosity, electrical conductivity, capacitance, absorption of organic solvents and water-based solutions, hydrophilicity, EMI shielding, electrode quality, wettability, contact angle, anti-fouling.

### Non-Graphene Carbon Material Foam

Conventional graphene foam appears, under a scanning electron microscope, to have large, open ring-like structures, typically 500 μm in size. The carbon foam generated using the Dual Laser process looks very different; see FIG. 7.

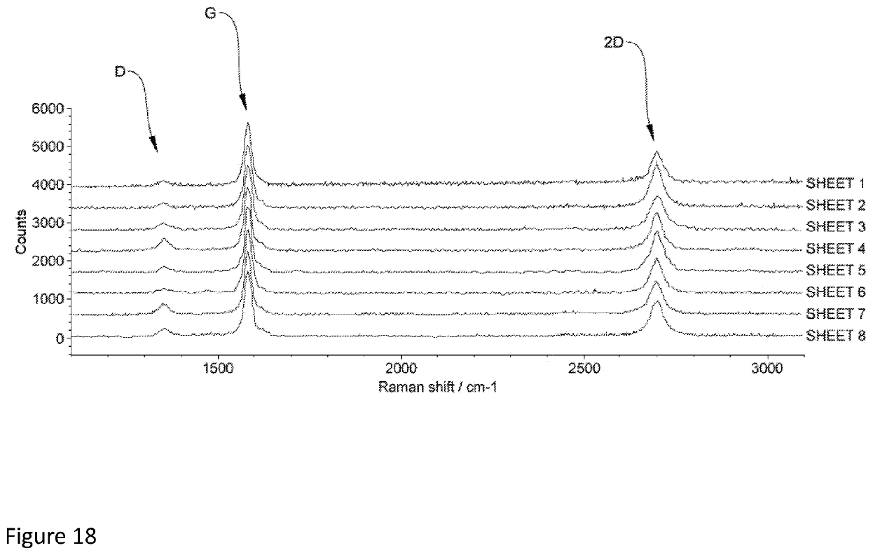

As noted earlier, graphene foam has a number of characteristics: it is hydrophobic, with low wettability. Raman analysis of a typical graphene foam reveals the following signatures: absence of a D peak; the 2D peak is higher than the G peak; the peak D: peak G ratio is close to zero. Yet one variant of the carbon foam generated using the Dual Laser process shares none of these characteristics; it is hydrophilic, with a contact angle below 20°; it lacks the tell-tale Raman spectrum signature of graphene: it shows a significant D peak; the 2D peak is significantly less than the G peak; the peak D: peak G ratio is significantly above zero. FIG. 18 shows the Raman shifts for eight sheets of carbon foam made using the Dual Laser process, showing the consistency of the Raman signature. It also shows a significant D peak; the 2D peak is less than the G peak; the peak D: peak G ratio is above zero. As we noted earlier, this Raman spectrum has much in common with carbon nano-onions. See also FIG. 15C, also from ‘Raman spectroscopy of polyhedral carbon nano-onions’. DOI: 10.1007/s00339-015-9315-9. The specific Dual Laser parameters used to create this carbon nano-onion variant of Gii carbon foam are in Table 5 below:

TABLE 5

| | First Laser | Second laser |
|---|---|---|
| Laser machine | S300 | S300 |
| Laser wavelength (nm) | Flexx - IR 1064 nm | CO2 10600 nm |
| Power (Watts) | 11 | 36 |
| Speed (mm/s) | 810.11 | 188.15 |
| PPI (pulses per inch) | n/a | 1000 |
| Frequency (Hz) | 80000 | n/a |
| DPI (Dot/inch) | 1000 | 1000 |
| Offset (mm) | 0 | 15 |
| Passes | 1 | 1 |

We can generalise to the following:

A carbon foam material made, at least in part, by the method defined in any of Features A-L above and that is hydrophilic, with a contact angle below 20°.

A carbon foam material made, at least in part, by the method defined in any of Features A-L above and with a Raman spectrum exhibiting a significant D peak; the 2D peak is less than the G peak; the peak D: peak G ratio is above zero.

A carbon nano-onion material made, at least in part, by the method defined in any of Features A-L above.

Note that devices may be characterised by their use of these materials and so we can generalise to the following:

A TENG device including an active layer comprising a carbon foam material made, at least in part, by the method defined in any of Features A-L above and that is hydrophilic, with a contact angle below 20°.

A TENG device including an active layer comprising a carbon foam material made, at least in part, by the method defined in any of Features A-L above and with a Raman spectrum exhibiting a significant D peak; the 2D peak is less than the G peak; the peak D: peak G ratio is above zero.

A TENG device including an active layer comprising a carbon nano-onion material, made, at least in part, by the method defined in any of Features A-L above.

### Features A-L are Summarised Here for Convenience:

### Group 1: Sub-Surface Carbon Foam

Feature A: Carbon foam created in a sub-surface region of a carbon pre-cursor material
Feature B: Carbon foam created in an encapsulated region of a carbon pre-cursor material
Feature C: Carbon foam created in a region of a carbon pre-cursor material, where the region has no substantial gas escape pathways
Feature D: Amorphous, non-graphene material adhering to the substrate

### Group 2: Dual Laser Processing

Feature E: Carbon foam created by laser ablating a sub-surface carbon foam region
Feature F: Non-graphene carbon foam created by laser ablating a sub-surface carbon foam region
Feature G: Dual lasers
Feature H: Electrical contacts positioned in carbon foam created by laser ablating a sub-surface carbon foam region
Feature I: Printing electrical contacts on the polyimide film and then creating the exposed carbon foam
Feature J: Tall tracks made in the carbon foam
Feature K: Applying the first and second lasers in different manufacturing facilities
Feature L: Scalable high speed manufacturing

### Section C: Case Study of Carbon Foam Made Using the Processes Described in Section A and B ABOCE, and Used in Teng Devices

The following section includes material from the paper ‘Three-dimensional graphene foam based triboelectric nanogenerators for energy systems and autonomous sensors’, Nano Energy, Volume 112, 2023, 108475, ISSN 2211-2855. Emma Keel, Ammara Ejaz, Michael Mckinlay, Manuel Pelayo, Marco Caffio, Des Gibson, Carlos García Nuñez. Note that some edits as to form have been made for consistency with other text in this specification. Citations have been omitted for brevity.

The resultant carbon foam described in preceding sections has many properties that make it especially interesting in TENGs. This carbon foam is referred to as Gii, or Gii carbon foam, Gii-Teng carbon foam and also 3DG or 3D graphene in this specification (note that for the reasons given earlier, although the 3DG may have some properties consistent with conventional graphene, it also has many properties that are not consistent with conventional graphene, and hence we generally do not think of it as a 3D graphene as such). A TENG using this Gii carbon foam, e.g. as an electropositive layer is referred to as a Gii-TENG device.

Error! Reference source not found. (see FIG. 26) presents a review of the performance of various carbon based TENGs, including Gii carbon foam; the Gii-based device exhibits record values of V_{oc}, short circuit current (I_{sc}) and output power density (Pₒᵤₜ), as well as, their operation frequency and best load resistance (R_{load}), the latter, useful for the application of TENG on wearable and portable IoT devices. Carbon based Gii-TENG has demonstrated great potential over conventional materials, e.g., SEG-PDMS TENG exhibiting powers 40 times higher than same TENG devices but based on Al-PDMS triboelectric layers.

Before, we study the results obtained in Gii-TENG, from FIG. 26, it is clear that Gii-TENG in presents the highest power density of 10.37 W/m² with a moderately low R_{load} of 40 MW, surpassing the record values obtained by CNTs based TENG.

Gii carbon foam is a variant of carbon foam with a high surface area and porosity, both expected to be highly beneficial for the successful formation of a triboelectric interface and the reduction of charge losses.

The key to Gii-TENG formation is the use of contact electrodes or active layer made of materials with different electron affinities. In solid state physics, the electron affinity is a surface property of a material which does not alter due to e.g., doping, but is affected by the crystallinity, chemistry, and texture of the surface. In this regard, Gii carbon foam presents a unique surface chemistry among all the carbon foam morphologies, and as such is expected to show a unique electron affinity in the study of TENG devices.

Gii carbon foam electron affinity, as a carbon-based material, is expected to be positive. Studies carried out on single layer probe electron affinities of around 3-4 eV for this material. In this scenario, the most effective strategy to design a Gii-TENG device would be to select second electrodes made of a material exhibiting a negative electron affinity. There are many materials showing negative electron affinities, including Kapton, PET, PVC and PDMS materials, typically chosen due to their compatibility with flexible substrate manufacturing processes.

In this work, we have designed, fabricated, and characterised Gii-TENG devices working in contact-separation mode, based on Gii carbon foam and polyimide (PI) as tribopositive and tribonegative materials respectively. Gii-TENG output characteristics have been studied, including V_{oc}, I_{sc} and Pₒᵤₜ as a function of device operation parameters, i.e., contact-separation frequency, maximum electrode distance, contact pressure and external R_{load}. Moreover, Gii-TENG electric outputs have been tested over long periods of time to evaluate the robustness, feasibility, and stability of the devices as energy source. Finally, Gii-TENG has been successfully used as energy source to power energy storage devices and demonstrated its validity as self-powered sensor in an energy autonomous sensing platform.

### 1. Materials and Methods

1.1 Fabrication of TENG based on Gii Carbon Foam

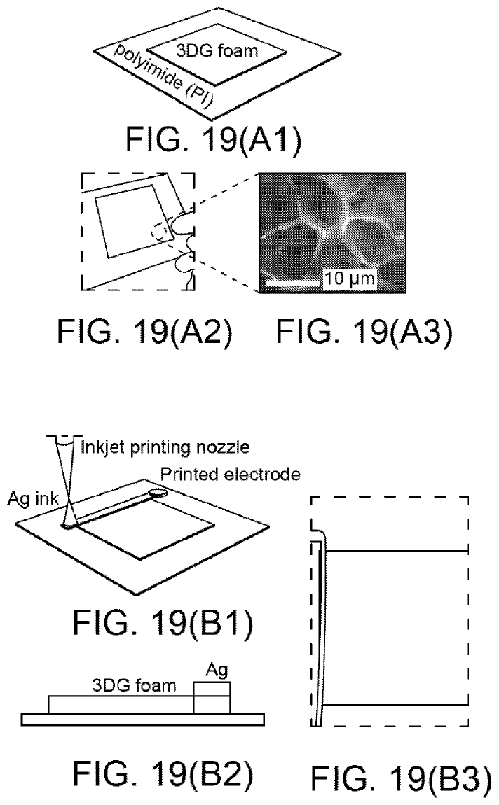

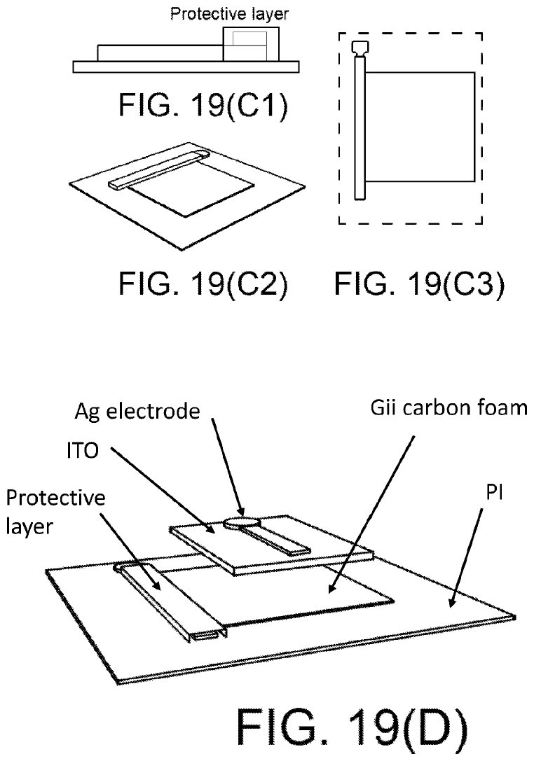

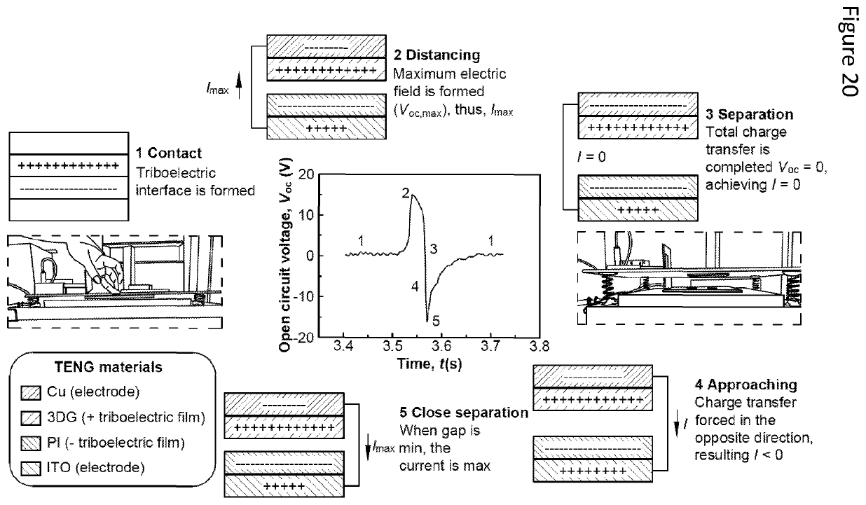

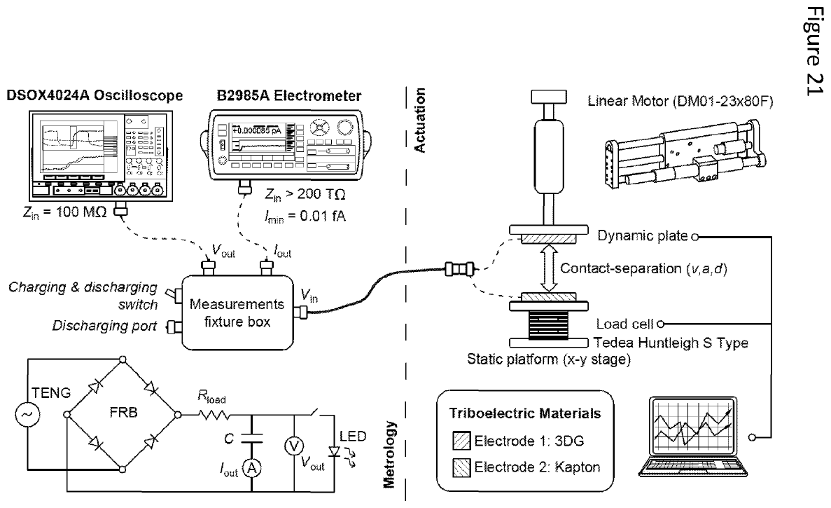

The Gii carbon foam material is made using the Dual Laser process described above; this is a catalyst free method of creating Gii carbon foam on a 125-mm thick Kapton polymide (PI) flexible substrate (Kapton® HN from UK insulations Ltd) to prevent the damage caused its transfer to foreign substrates; FIG. 19A-D are schematic images of the Gii carbon foam active layer on a PI substrate, with an ITO electronegative active layer. The production process is carried out using a hard mask to limit the area of the Gii carbon foam formed on the substrate, FIG. 19(A1). This method allows the growth of Gii carbon foam at A4 paper size. In this work, we have restricted the study of TENG devices using Gii carbon foam with areas of 1×15 mm² and 40×40 mm² (i.e., 15 mm² and 1,600 mm²).

The characteristics of the Gii carbon foam used in this work, including the morphology (pore size and density) and structure (defects density and number of carbon layers) were analysed by scanning electron microscopy (SEM), and Raman spectroscopy, and described elsewhere in this specification. Briefly, the resulting Gii carbon foam exhibited a high level of uniformity as represented in the 3D schematic diagram of FIG. 19 (A1) and further supported by the photograph of FIG. 19 (A2). The high density of porous with micrometric size observed by SEM in this Gii carbon foam (FIG. 19 (A3) make this material light-weight, and unique for the generation, transfer, and storage of charge. Note that Gii carbon foam is referenced as ‘3DG’ foam in these figures.

After Gil carbon foam deposition onto the substrate, one edge of the Gil carbon foam was metallised using inkjet printing method, see FIG. 19(B). An Ag conductive path was printed on Gii carbon foam as illustrated by the 3D schematics of FIG. 19 (B1) and FIG. 19 (B2). To prevent any damage of the metallised areas, a protective layer was deposited on top Ag as schematically presented in FIG. 19 (C1) and FIG. 19 (C2) and in the photograph of FIG. 19 (C3).

We can re-cap on FIG. 19 as follows: FIG. 1(A) Deposition of Gil carbon foam on a flexible substrate; (A1) 3D CAD schematic diagram showing the resulting Gii carbon foam deposited on PI substrate; (A2) Photograph of the Gii carbon foam patterned directly on PI substrate; (A4) SEM image presenting the porous structure of Gil carbon foam. (B) Ag electrodes inkjet printed on Gii carbon foam; (B1) perspective and (B2) side views of the layer structure; (B3) photograph of the Ag electrodes printed on Gii carbon foam. (C) 3D schematic diagram of the Gii carbon foam electrode, right after the encapsulation of the conductive Ag paths; (C1) side and (C2) perspective views of the layer structured after electrode encapsulation and (C3) photograph of the resulting Gii carbon foam tribopositive electrode. (D) Diagram presenting the TENG materials, including Gii carbon foam electrode (bottom) and PET electrode (top).

That concludes the fabrication of the tribo-positive electrode based on Gii carbon foam.

The tribo-negative electrode consisted of an ITO 130-nm thick film (conductivity 45-65 W/O) deposited on a PET 5-mm thick substrate (from Merck, no. 639303). FIG. 19(D) shows a 3D schematic diagram of the two electrodes during the separation stage (see figure legend for more details about materials and structure).

The experimental method described in FIG. 19 was utilised to carry out the individual preparation of tribo-positive and tribo-negative electrodes compatible with the characterisation setup that will be described later. In this work, we have also explored a simple and effective design to integrate both electrodes in a portable TENG, making the resulting device to be more compatible with portable applications. For that, Gii carbon foam based TENGs have been designed with a standard vertical configuration, where two electrodes were vertically stacked, using two spongy separators, allowing their contact during the pressure stage, and separation during the release stage.

### 1.2 Characterisation of TENG

### 1.2.1 TENG Working Principle

The portable Gii-TENG devices presented in FIG. 19 were characterised by tapping them at various frequencies (1-4 Hz), and pressures. These tapping experiments were carried out directly by hand on the portable device and by attaching the portable Gii-TENG to a homemade setup, see FIG. 20, designed to increase the reproducibility of the results (see insets of FIG. 20). To understand better the energy generated by these devices, FIG. 20 summarises the working principle of TENG devices presented in this work. The figure contains also a small legend detailing the materials used for the electrodes and triboelectric materials. At the centre of the figure, one could find a characteristic V_{oc} peak measured as a function of time. The peak formed during the contact-separation experiments could be described in 5 stages. In the stage (1), the so-called contact, both triboelectric materials are in mechanical contact, resulting in the creation of a triboelectric layer. That effect is also known as charge electrification, and essentially consists of the separation of positive and negative charges at both sides of the interface.

Here, the electron affinity of the materials plays a key role. Gii carbon foam acts as an electropositive material transferring negative charges to Kapton (electronegative material). The contact and separation of these two materials requires a number of cycles in order to reach a constant charge density, also known as triboelectric charge density (s_{T}). In this regard, it has been observed that Gii-TENG exhibits an increase of the V_{oc} over time due to the dynamic change of s_{T} related to the hysteretic behaviour of the contact force response in these devices. Once the Gii-TENG reaches the stationary state (i.e., V_{oc} saturates), the energy generation could be used to produce a constant electric power. For that reason, it is a common practice to ‘warm up’ TENG devices for a short period of time prior to their use as energy source, ensuring the generation of a constant output power. In the stage (2), when both materials are being released (or separated due to the effect of an external force) a small gap is formed between the two materials, and an electric field is generated by the two opposite charges separated at a distance.

In order to screen that potential difference between the two electrodes (V), electrons will be driven to flow from one electrode to the other through the external load. Once the electric potential is fully screened, i.e., V=0, the current in the external circuit is zero (see stage 3 in FIG. 20). From the released position, if the electrodes are pressed one towards the other (stage 4), the triboelectric charges, that did not exist in the original stage, and in particular the induced potential difference still existing as one could see in the schematic diagram, will begin to decrease to zero, producing a transfer of charge flowing back to their origin through the external load. As it happens in the case of stage (2), when stage (4) is initiated, the current is maximum (min voltage), and when the materials become in close proximity (stage 5), the voltage will be maximum because both the screening effect in the electrodes is minimum and the distance between electrodes is minimum.

FIG. 20 re-cap: Schematic diagram of the TENG working principle. The centre of the figure shows a characteristic V_{oc} peak observed during contact-separation experiments, describing the stages of the energy generation: (1) contact; (2) distancing; (3) separation; (4) approaching; (5) close separation. Photographs show the laboratory based system to characterise manually the output characteristics of TENG.

### 1.2.2 Automatic Actuation-Based Setup

To understand the energy generation of the Gii-TENG, both electrodes have been attached to a homemade automatic actuation system capable to contact and separate the electrodes at a controlled frequency, gap distance, and pressure. This system allows us also to carry out long cyclic test (i.e., thousands of contact-separation cycles) to estimate the percent of retention of the Gii-TENG. FIG. 21 shows a schematic diagram of the setup, comprising both metrology and actuation parts. In the actuation part (see right panel in FIG. 21), one of the electrodes was attached to a vertical platform mounted on a X-Y stage fixed to an optical table. The second electrode was attached to a dynamic plate mounted on a linear motor with a stroke of 100 mm and a maximum force of 22 N (DM01-23×80F-HP-H-100_MS13 from Quinn systems).

For the frequency study, the linear motor was programmed to travel a fixed distance (gap between electrodes), increasing the speed and the acceleration to cover a wide range of frequencies. To measure the pressure exerted by the dynamic plate to the static one, a compression-based load cell (No. 414-0859, from RS components) was attached to the rear part of the static platform. The pressure of the dynamic stage exerted on the static stage during the contact step was measured in the equivalent conditions utilised during the TENG characterisation (i.e., speed, acceleration, deceleration, and gap).

For the electric characterisation (see left panel in FIG. 21), the wires from the two triboelectric materials were soldered to a BNC cable, and that cable was connected to a fixture box capable to function either in voltage or current modes. In voltage mode, the output of the box was connected to an oscilloscope (DSOX4024A Oscilloscope from Keysight) through a 100 MW input impedance probe (BKPR2000B-ND from B&K Precision), ensuring the accurate measurement of the V_{oc}. In the current mode, the box allows the exchange of a load resistor (R_{load}) to characterise the I_{sc} as a function of R_{load}. The output of the box was connected to an electrometer with an input impedance above 200 TW and a resolution of 0.01 fA (B2985A Electrometer from Keysight). Both oscilloscope and electrometer were connected to the PC via USB and interfaced through NI Labview, allowing the measurement of output voltage Vₒᵤₜ and output current (Iout) as a function of time and for various contact-separation frequencies, gap distances and pressures. TENG output characteristics consist of AC peaks (See FIG. 20). The cyclic spectra obtained in the studies were analysed using a Python script, carrying out the identification of the peaks (maxima and minima), the calculation of the mean (for the maxima and minima) and their standard error, and finally the estimation of the peak-to-peak voltage, used here as Vₒᵤₜ.

FIG. 21 re-cap: Schematic diagram of the automatic actuation setup built to characterise Gii-TENG devices. Left panel (Metrology) describes the metrology of the setup, including voltage and current measurements, as well as a fixture box to characterise electric properties of capacitors and loads. Right panel (Actuation) presents the linear motor, stages and load cell utilised to control the contact-separation frequency, gap and pressure during the experiments.

The fixture box showed in FIG. 21 also has a charging/discharging switch, an energy storing device input inside the box (to prevent noise effects) and a discharging output port (mainly used to drive small devices such as LEDs, displays, actuators, etc.). In the voltage mode, the Labview interface allows to monitor the charging of an energy storage device (e.g., capacitor, supercapacitor or battery) and its discharging cycle connecting a load. In current mode, and with the high precision provided by the electrometer, the fixture box enables monitoring of both current density flowing to the capacitor and quantifies the charge density stored in the capacitor together with the potential current leakage with time.

### 1.3 Theoretical Analysis of Gii-TENG Output Characteristics

Distance dependent model (DDM) has been used here to simulate V_{oc} of Gii-TENG as a function of both contact-separation frequency and gap. Fitting of the experimental results with simulations identified the characteristic triboelectric charge density (s_{T}), as a key parameter to optimise the performance of Gii-TENG.

The expression for V_{oc} is as follows:

V_{oc}(σ_{T},ε_{3DG},ε_{PET},z,w)=φ₁−φ₂ (1)

where φ₁ and φ₂ are the electric potentials of triboelectric materials, see FIG. 20.

These potentials depend on both material properties and device structure. The former includes s_{T} and the dielectric permittivity of the tribo-positive (ε_{3DG}) and tribo-negative (ε_{PET}) materials. The latter comprises the gap distance (z), and the thickness of the triboelectric materials (w_{3DG} and w_{PET}). For the sake of clarity, the expression for the electric potential is given by Equation 2:

$${ϕ}_{i} = {\frac{\pm {σ}_{T}}{π {ε}_{i}} [ M ( x ) ]}_{{x}_{i}}^{{x}_{i} + z} \qquad ( 2 )$$

where M(x) is a periodic function that depends on the relative position of the electrodes with respect to the maximum gap distance. The V_{oc} expression (Eq. 1) was calculated across a range of gap distances (z), and then, using the non-linear curve fit utility in Origin Lab, the unknown s_{T} value was obtained statistically. Simulations have been done with a w_{3DG} of 4 mm, w_{PET} of 25.3 mm, z ranged between 10 and 90 mm, ε_{PET} of ε3.3ε₀, and ε_{3DG} ranged between 28, and 8ε₀ (ε₀ being the dielectric permittivity of vacuum).

### 2. Results and Discussion

### 2.1 Miniaturised Gii-TENG

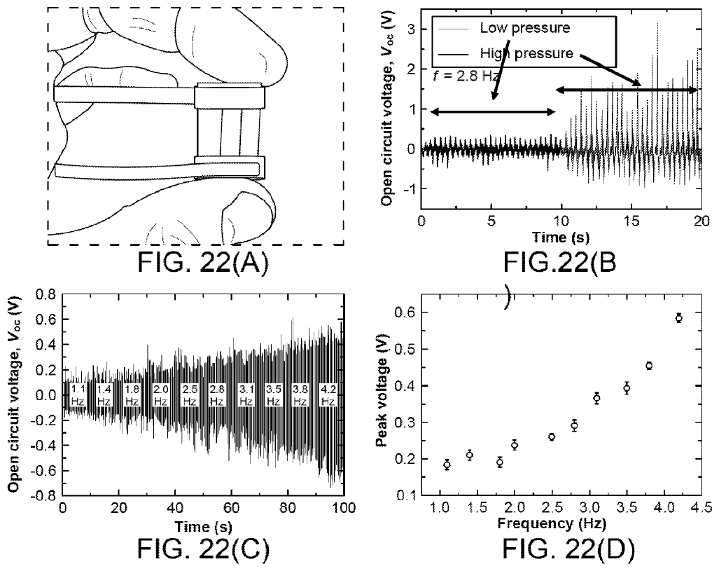

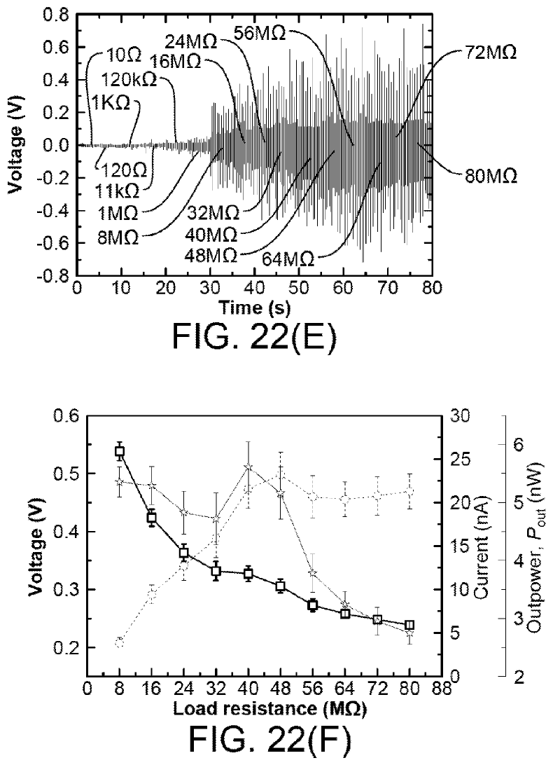

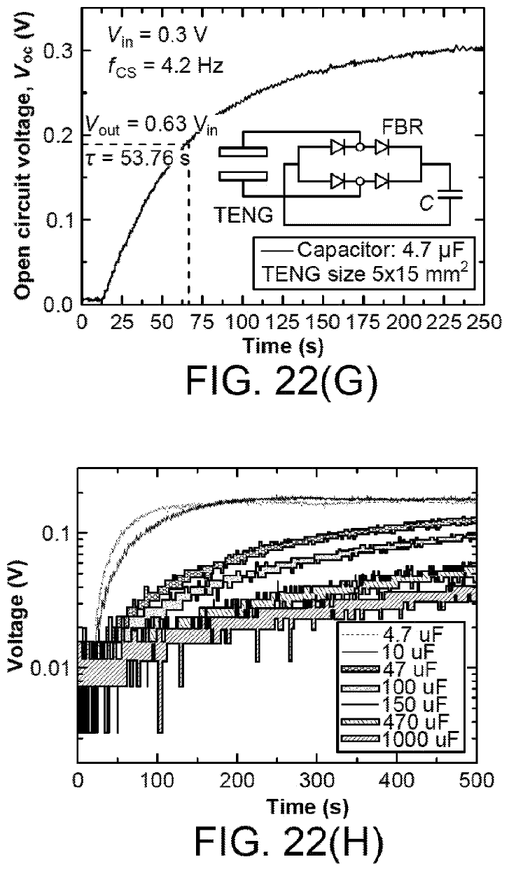

Firstly, we present the characteristics of the miniaturised Gii-TENG with an effective area of 5×15 mm² (i.e., 75 mm²), limited by the Gii carbon foam exposed area, see FIG. 22(A). In this section, electric characterisation of this small Gii-TENG is described, including V_{oc} characterised as a function of the contact-separation pressure, see FIG. 22(B) and frequency FIG. 22(C, D), as well as the voltage, current and output power (Pₒᵤₜ) measured as a function of the R_{load} FIG. 22(E, F).

The section will conclude with a demonstration of power generation from mechanical energy and transfer of charge to an energy storage device with different capacitances, see FIG. 22(G, H).

FIG. 22 re-cap: (A) Photograph of the miniaturised Gii-TENG with an effective carbon foam area of 75 mm². (B) V_{oc} vs time for various contact-separation pressures, studying 13 kPa (low pressure) and 130 kPa (high pressure) at a constant contact-separation frequency of 2.8 Hz. (C) V_{oc} vs time, varying the contact-separation frequency between 1.1 to 4.2 Hz. (D) Peak voltage (Vₚ) extracted from (c) vs frequency. (E) Voltage produced by the Gii-TENG showed in (a) connected to an external load resistor (R_{load}), @130 kPa and 4.2 Hz). (F) Voltage, current and output power vs R_{load}. (G) Charging characteristic curve of a 4.7 mF capacitor charged by Gii-TENG device presented in (a); inset: electronic circuit used to transfer energy from Gii-TENG to a capacitor. (H) Comparison of charging curves obtained for various capacitors.

The V_{oc} of the miniaturised Gii-TENG is characterised as a function of the pressure applied during the contact stage described in FIG. 20. For that, low and high pressures of 13 and 130 kPa, respectively, have been tested. The study exhibits a clear increase of the peak voltage of around a factor 5 when high pressure is applied, see FIG. 22(B). This result indicates the deformation behaviour of interfacial nanostructures existing in Gii carbon foam during the contact process. This deformation is expected to determine the pressure-voltage relationship of Gii-TENG, in good agreement with previous studies, where triboelectric charge density was improved by the contact surface between the triboelectric materials via nano-texturization of the surface leading to a drastic increase of the contact pressure.

The unique porous nanostructure of Gii carbon foam utilised in these TENG devices, see FIG. 19(A3), offers a surface enlargement effect by interfacial nanostructure formation, preventing the use of any complex and costly lithography step. However, this condition is only observed when the applied contact pressure is stronger than certain threshold pressure to make the full contact conditions. In our case, the comparison between low- and high-pressure conditions, evidenced that forces of 1 and 10 N applied to the 75 mm² area of our Gii-TENG, resulting in pressures of 13 and 130 kPa, both exhibiting energy generation, which indicates that the pressure threshold might be below that range. Regarding the pressure range, studies reported in the literature indicated that low pressures around 16 kPa only reached 0.25% of the so-called real contact area in flat based TENG. However, this real contact area could be enhanced towards 82% by increasing the pressure up to the MPa range (typically observed in mechanical energy produced by ocean waves). These numbers evidence that large dynamic range of contact-pressure that TENG device present, keeping in mind that depending on the properties of the material, the utilisation of large pressure could lead to deterioration of material properties via material transfer or plastic deformation.

FIG. 22(C) presents the study of V_{oc} as a function of time for various frequencies ranging between 1.1 and 4.2 Hz. The results clearly indicate a drastic increase of the V_{oc} with the frequency from 0.18±0.02 V (@1.1 Hz) up to 0.58±0.02 V (@4.2 Hz), which is a factor 3 increase on the measured V_{oc}. The output signal of the TENG probes the sensitivity of the device voltage generation as a function of the frequency which makes the devices to be highly tuneable depending on the application. For example, human mechanical energy produced by breathing (0.1 Hz), heart beating (0.6 Hz), blinking (1 Hz), walking (2 Hz), running (5 Hz), and typing (7 Hz), will produce voltages from few millivolts up to few volts, using the devices showed in FIG. 22(A). This increase of V_{oc} with frequency experimentally observed in FIG. 22(D) has not been explained by theoretical models, and theoretical calculations of TENG output characteristics with frequency. Triboelectricity mainly governed by electron, ion and charged material transfer, has been observed here to be highly influenced by the separation of the triboelectric surfaces and the realising (distancing) speed achieved from the contact stage, see FIG. 20.

The increase of the frequency leads to a greater V_{oc} mainly due to the higher kinetic energy of the plates when they are brought in contact. The deformation of the triboelectric material for certain values of applied pressures during the contact stage, alters the electric field causing the charge transfer between electrodes. In this regard, the product between the electric field across the dielectrics of the TENG and their thickness strongly depends on the applied pressure, the latter being dependent on the frequency. Further investigations of the working mechanism of TENG are needed in order to adapt the theoretical model to the experimental evidence. To demonstrate the relationship between contact pressure and applied frequency, measurements have been carried out mounting a load cell in the equivalent position of one of the electrodes, see FIG. 21. The studies conclude that contact pressure increases with the frequency, justifying the observed increase not only in miniaturised Gii-TENG presented in this section but also in larger-scale devices discussed later on.

The energy generation features of our Gii-TENGs have been evaluated by connecting the miniaturised device showed in FIG. 22(A) to an external load. For that, R_{load} ranged between 10 Ohms and 80 MOhms (FIG. 22(E)). From those studies, one could conclude that there was a threshold in R_{load} above what the Gii-TENG started showing effective energy generation. In other words, R_{load} above 1 MOhm exhibited a partial matching of electric impedance between the generator and the external load (FIG. 22(E)). Further optimisation of the impedance between components, resulting in the minimisation of impedance mismatch for R_{load} above 40 MOhms, above what the voltage generated by the Gii-TENG showed a constant value of around 0.45-0.50 V. The I_{sc} of the same devices was measured by using an electrometer as a function of the same R_{load}, showing the opposite behaviour as the voltage. In good agreement with previous works reported on TENG, the I_{sc} decreases with R_{load}, mainly due to the increase of the voltage as the Gii-TENG internal impedance is matched with the external load, see FIG. 22(F), well-known as Ohmic loss. FIG. 22(F) summarises the voltage, current and output power generated by the TENG as a function of the R_{load}.

From that figure, it is worth noting that there is an optimum R_{load} (40 MOhms) where the Gii-TENG exhibited the best output power of 5.6 nW (i.e., 5.6 mW/m² power density), which set the best conditions for the Gii-TENG to be connected to external loads, e.g., energy storage devices, sensors, electronic devices, etc. As we will demonstrate in the next section, scaling up the Gii-TENG device by increasing the area of the triboelectric materials, changes the internal impedance of the device, shifting the optimum R_{load} towards a different value. One of the main characteristics observed in our miniaturised Gii-TENG, that will be also evident in our large-scale Gii-TENG is the low R_{load} (range of tens of MOhms) compared to other reported works on graphene based TENG, exhibiting best Pₒᵤₜ at R_{load} in the hundreds of MOhms (See FIG. 26) Click or tap here to enter text. That drastic change in the internal impedance of our Gii-TENG makes this device to be a good energy generator, presenting low energy losses due to power dissipation, and reducing the use of complex power management boards. TENG is well-known to have a large impedance and unbalanced load matching with external components. In this work, Gii carbon foam has demonstrated to have produce an inherent low impedance, easing their connectivity to external devices.

In spite of its small size, our miniaturised Gii-TENG was tested as an energy generator to charge capacitors of different capacitances. FIG. 22 re-cap: (g) illustrates the charging curve of a capacitor with a capacitance of 4.7 mF, charged with a miniaturised Gii-TENG working at 4.2 Hz. To charge this capacitor, the AC signal generated by the Gii-TENG was transformed into a DC signal using a full bridge rectifier (FBR) consisting of a diode bridge (see inset of FIG. 22(G). The experiment probed the successful charge of a small capacitor, achieving saturation voltages of 0.3 V with charging times around 53.75 s. The charging time was calculated from the input voltage (Vᵢₙ) of 0.3 V, and the time TENG takes to charge 63% of the Vᵢₙ. This method has been used to compare the charging time produced by these small Gii-TENG devices to charge capacitors with capacitances ranged between 4.7 mF to 1 mF. FIG. 22(H) summarises the comparison of all the charging curves. One could conclude from that figure that the miniaturised Gii-TENG is capable to charge rapidly small capacitors with values of 4.7 mF (t=56 s) and 10 mF (t=94 s), exhibiting more difficulties to reach Vᵢₙ as the capacitance of the capacitors increases (e.g., 47 mF with t=398 s, or 100 mF with t>500 s).

This is not necessarily a negative feature, because miniaturised Gii-TENG could be used as an active component in boosted Gii-TENG configurations, where two or more Gii-TENGs are connected in series to enhance the performance of the devices through a feeding process. In that configuration, small capacitors charge larger ones (cascade structure). In that scenario, small Gii-TENG like the one developed here could be used to provide charges to the small capacitors, being part of a larger power generation system.

### 2.2 Large Scale Gii-TENG

### 2.2.1 Study of Frequency and Triboelectric Electrodes Gap Distance

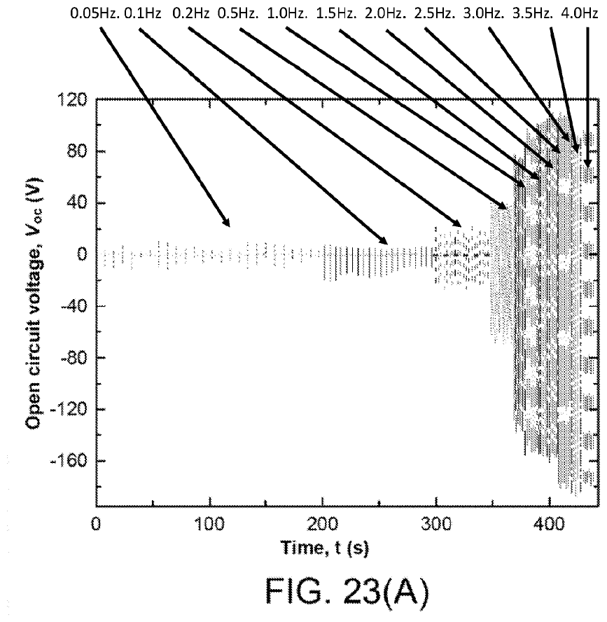

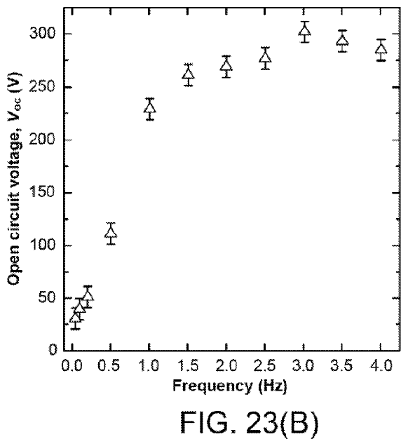

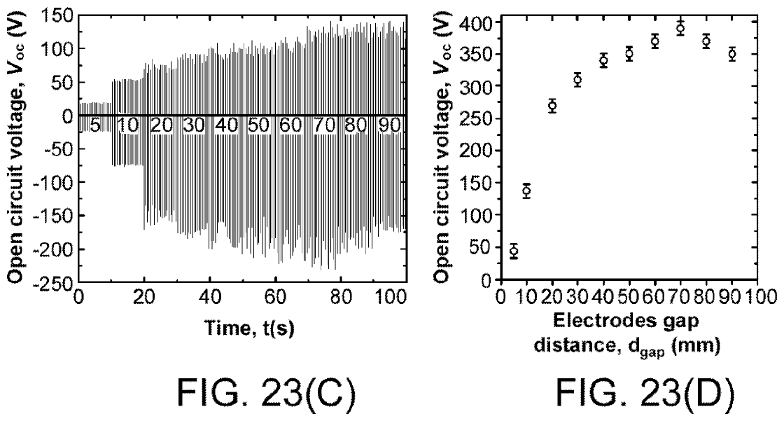

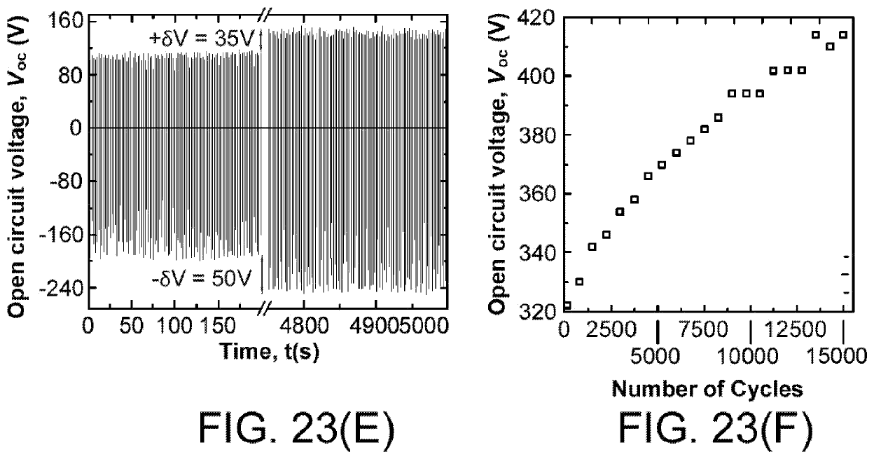

The role of the frequency and electrodes maximum gap distance (d_{gap}) in Gii-TENG devices working in contact-separation mode, see FIG. 20, was tested in larger devices than those discussed in the former section. In this study, Gii-TENG devices with an effective area of 16 cm² were characterised using the setup described in FIG. 21. FIG. 23(A) presents the V_{oc} measured for different frequencies ranged from 50 mHz to 4 Hz. From that figure, one could easily observe that V_{oc} increases with the frequency, in good agreement with the results obtained in miniaturised devices, see FIG. 22(C). For example, the frequencies 50 mHz and 4 Hz produced V_{oc} of 26±5 V and 285±7 V, respectively.

This increase was observed for threshold values of frequency above 0.2 Hz, exhibiting a drastic enhancement of V_{oc} for frequencies above 1 Hz. For the sake of clarity, FIG. 23(B) shows the mean of the peak-to-peak voltages, and their standard error, extracted from FIG. 23(A) and called here V_{oc}. In this figure, a linear regression of the experimental data is observed following a function V_{oc}=230 V·s*f (Hz)@frequencies below 1 Hz. This function allows the tunability of the Gii-TENG working regime, depending on either the application electric energy requirements or mechanical energy frequency. Above frequencies of 1 Hz, one observes a saturation of the V_{oc} values, indicating that frequencies around 3 Hz has a positive effect on V_{oc}, producing maximum V_{oc} values ranged between 275-300 V, leading to a more efficient transport of positive and negative charges to the electrodes of the Gii-TENG (see schematic in FIG. 20). That means, the faster the electrodes separate, the more carrier density with oppositive charge is accumulated in the electrodes of the Gii-TENG, and thus, the higher electric field is built during the separation stage. Similar effect is observed during the approaching stage.

As a result of that, the peak-to-peak voltage, or called here V_{oc} increases with the frequency, see FIG. 23(B). However, this mechanism exhibited a maximum, and a decay for frequencies above 3 Hz is observed. That decrease of the V_{oc} for frequencies >3 Hz is in good agreement with the study of the pressure as a function of the applied frequency. In our described setup and device structure, results demonstrated an optimum contact pressure reached at applied frequencies around 3 Hz, which is in good agreement with the V_{oc} graph showed in FIG. 23(B).

FIG. 23 re-cap: Characterisation of Gii-TENG devices with an effective area of 16 cm². (a) V_{oc} vs time for various frequencies. (b) V_{oc} vs frequency, including experimental data (red circles) and simulations (pink line); data extracted from (a). (c) V_{oc} vs time for different electrodes gap distances (expressed in mm). (d) V_{oc} vs electrodes gap distance; extracted from (c). (e) Stability cyclic test measured in Gii—TENG at a frequency of 3 Hz and d_{gap}=70 mm. (f) V_{oc} vs number of contact-separation cycles; extracted from (e).

FIG. 23(C) presents the results obtained for V_{oc} measured as a function of the electrode gap distance. This distance corresponds to the maximum distance achieved during the separation stage of the experiment. From this study two conclusions emerge: i) V_{oc} increases with d_{gap} and ii) V_{oc} exhibits maximum values at d_{gap} of 70 mm, showing a reduction of the V_{oc} for distances above that value. This result indicates that the electric field between electrodes highly depends on the distance between them, where V_{oc} is expected to increase with d_{gap}. By increasing the distance between electrodes, the electric field is reduced for the same electric potential. From FIG. 6(b), one could understand that at d_{gap}<70 mm, the decrease of the electric field due to the increase of d_{gap} is overcompensated by the time left to the charges to accumulate at each electrode, resulting in a net increase of V_{oc}. For d_{gap}<70 mm, maximum charge density accumulated at the electrodes was reached, d_{gap} being the only factor limiting V_{oc}. This influence of gap distance on the V_{oc} has been also interpreted using an electric equivalent circuit, where V_{oc} depends inversely on the capacitance of the triboelectric electrodes; in that regard, the increase of the d_{gap} produces a decrease of the capacitance between the electrodes, leading to an increase of the V_{oc}-FIG. 23(D) includes the experimental values of V_{oc} (obtained from FIG. 23(C) as a function of d_{gap} along with the fitting values simulated by the DDM. This model was fitted using OriginLab's non-linear fit utility to obtain a variety of Or values for ε_{3DG} ranged between 280 and 880, resulting in Or values ranged from 0.890 mC/m² to 1.704 mC/m², respectively. For every value of ε_{3DG} tested, an R² value of ~0.95 was calculated. The good fitting of the model with the experimental data confirms the relationship between the V_{oc} and the distance between electrodes, exhibiting a stable output response in voltage of the Gii-TENG for gaps above 40 mm. Further experiments will be needed to determine the behaviour of the Gii-TENG at higher gaps. For comparison, MXene-3DG TENG obtain a maximum σ_{T} value of 0.150 mC/m² which is one order of magnitude lower σ_{T} than those obtained with Gii-TENG.

### 2.2.2 Stability Cyclic Study of Gii-TENG

The stability of the Gii-TENG output characteristics have been evaluated by subjecting Gii-TENG devices to 15,000 contact-separation cycles at a frequency of 3 Hz, and d_{gap}=70 mm, see FIG. 23(E). Results indicate that V_{oc} increases over time, i.e., the amplitude of the voltage generated by the Gii-TENG is greater with the number of cycles-see FIG. 23(F). This observation agrees with previous results reported in the literature suggesting that Gii-TENG devices require a number of cycles to ‘warm-up’, i.e., to reach a constant triboelectric charge density at the triboelectric materials. The time that a Gii-TENG needs to reach the steady-state stage not only depends on the triboelectric materials, but also on the frequency, applied pressure, and electrodes distance.

This makes the determination of the warm-up period to be characteristics of the particular TENG and experimental conditions. However, our Gii-TENG exhibited a unique feature that—to the best of our knowledge—has not been observed yet. Standard TENG typically reach saturated V_{oc} after a few contact-separation cycles (within minutes, depending on the frequency). In contrast, FIG. 23(CE) and FIG. 23(F) clearly highlight the non-steady performance of our Gii-TENG, exhibiting a clear increase of the V_{oc} within the window of analysis. Moreover, from FIG. 23(E), one could conclude that max and min voltages increase around 35 and 50 V, respectively, after thousands of contact-separation cycles. This is even more evident in the FIG. 23(F) extracted from FIG. 23(E), where Gii-TENG output voltage does not show saturation. The constant increase of the V_{oc} from 320 V (first few contact-separation cycles) up to 416 V (after 15 k cycles), being a factor 1.3 increase.

Another observation that we can make here is about the stability of the material. During long lasting cyclic test, material transfer from one electrode to the second one due to several contact-separation cycles, could hinder the stability of the Gii-TENGs. FIG. 23(F) probes a great level of stability in our devices with a positive creation of voltage over time. Other works using CVD graphene and polyimides as triboelectric materials, did show a worst performance, exhibiting decrease about 5.1% in the V_{oc} after only 1,000 contact-separation cycles, and a dramatic decrease of V_{oc} by 56.3% after 1,300 cycles. The absence of saturation and great material stability makes this 16 cm² Gii-TENG a very promising mechanical energy harvester in terms of output characteristics.

### 2.2.3 Characterisation of Gii-TENG as Energy Source for Energy Storage Devices

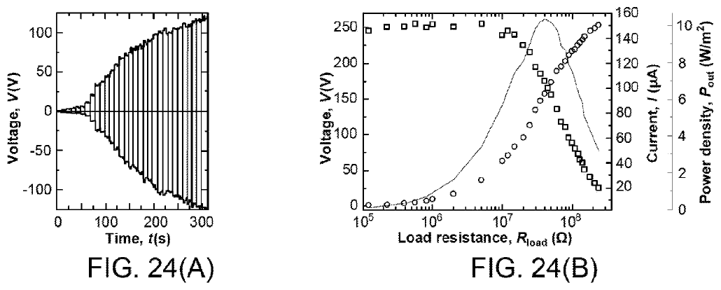

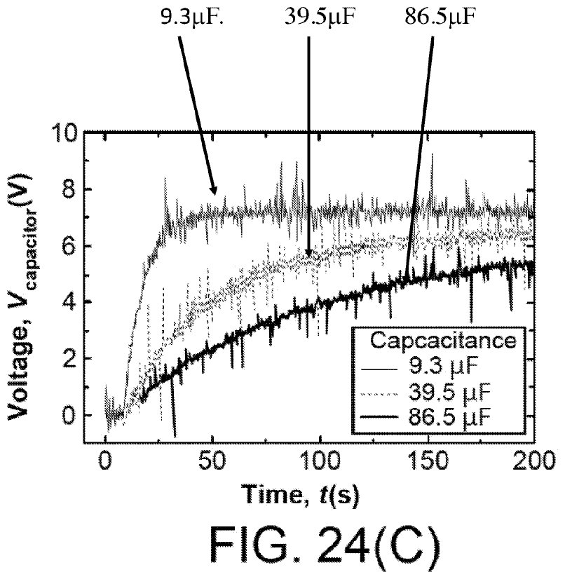

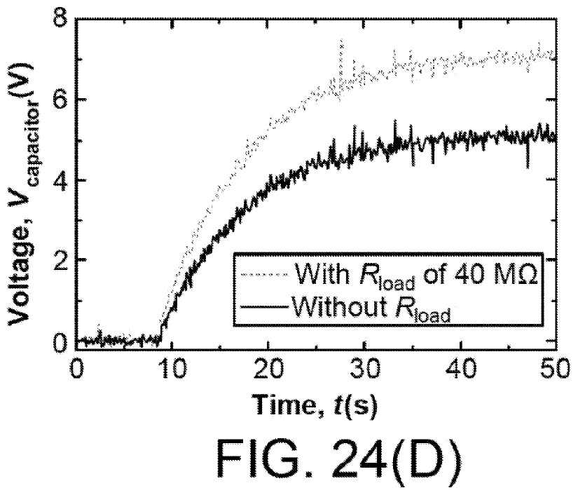

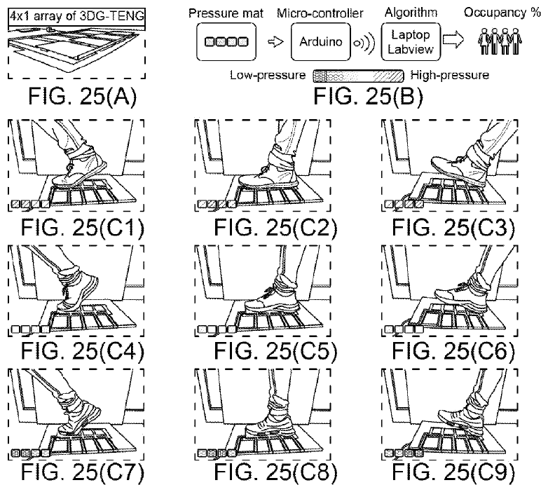

FIG. 23(A-D) have been used to operate the Gii-TENG devices at optimum conditions. In this regard, operating the Gii-TENG devices with a frequency of 3 Hz and a gap distance of 70 mm, the output power generated by the Gii-TENG has been evaluated FIG. 24(A). For that end, voltage and current have been measured as a function of the R_{load} ranged between 120 kOhms and 240 MOhms. FIG. 24(B) presents the summary of the obtained results, where voltage has been obtained from FIG. 24(A). In that figure, one could extract three conclusions: i) the peak-to-peak voltage exhibited a transition between tens of volts measured at R_{load}<10 MOhms and 250 V measured at R_{load}>100 MOhms; ii) the current exhibited the opposite transition, with high currents of 150 mA measured at R_{load}<10 MOhms and low currents of tens of mA measured at R_{load}>300 MOhms; iii) the output power showed a maximum value of around 10.37 W/m² at R_{load} around 40 MOhms. Compare with other carbon nanostructures based TENG, Gii carbon foam presents higher output powers per unit of area and weight—see Table 1 in FIG. 26.

For example, CNT based TENG demonstrated Pₒᵤₜ of 8 W/m² being a factor 1.4 lower than that obtained here with Gii-carbon foam. Comparing our CVD 3DG with other graphene synthesised by techniques such as laser induced processes, results also indicate a drastic improvement of the Pₒᵤₜ from 2.36-3.06 W/m² to 10.37 W/m² that we demonstrated in this work. Moreover, CVD technique has demonstrated to produce a lower internal impedance graphene foam, compared to laser induce graphene (LIG) and shear exfoliated graphene (SEG), with low R_{load} of 40 MW exhibiting the maximum Pₒᵤₜ compared to other synthesis techniques, resulting in large internal impedances, requiring thus larger R_{load} of 70, and 200 for LIG and SEG, respectively. In contrast, crumble graphene has demonstrated record values of low internal resistance, with R_{load} of 2 MOhms to produce maximum output powers. However, that output power was observed to be orders of magnitudes below those reported here (i.e., 0.0025 W/m²).

A large Gii-TENG has been tested as an energy source to charge capacitors of different capacitances ranged between 9.3 mF and 86.5 mF. FIG. 24(C) presents the characteristic curves of these capacitors charged by our large Gii-TENG operated at 3 Hz and using a d_{gap} of 70 mm. Similar to the case of the miniaturised Gii-TENG presented in FIG. 22(G), this Gii-TENG was connected to a capacitor. The result of the study demonstrates an enhanced performance in Gii-TENG charging low capacitance capacitors, e.g., 9.3 mF, exhibiting a saturation voltage of around 7 V (i.e., 100% of the input voltage or also called here Vᵢₙ) in less than 30 s. As the capacitance of the energy storage devices increased, the Gii-TENG devices needed more time to reach the saturation level. For the sake of comparison, at 200s, Gii-TENG was able to reach 92.85% and 78.57% of the Vᵢₙ. These enhanced values were obtained by using the R_{load} of 40 MOhms optimised in FIG. 24(A,B). The connected in series with the R_{load} demonstrated to be a good energy source for charging the capacitor, the absence of this load resistor hindering the charging time—see FIG. 24(D). This result evidences the high internal impedance of TENG devices, making their integration in external circuits challenging. As such their associated energy losses are one of the main drawbacks to be addressed.

FIG. 24 re-cap: Characterisation of Gii-TENG devices with an effective area of 75 cm². (A) Gii-TENG voltage vs time for various R_{load} (from left to right: 120 kW, 220 kW, 390 kW, 560 kW, 820 kW, 1 MW, 2 MW, 5 MW, 10 MW, 12 MW, 15 MW, 20 MW, 25 MW, 30 MW, 35 MW, 40 MW, 45 MW, 5 MW, 60 MW, 70 MW, 80 MW, 90 MW, 100 MW, 110 MW, 120 MW, 130 MW, 140 MW, 150 MW, 180 MW, 210 MW, and 240 MW). (B) TENG characteristics, including Vₚₚ, I and Pₒᵤₜ VS R_{load} extracted from (a). (C) Characteristic curves of 9.3, 39.5 and 86.5 mF capacitors charged by using Gii-TENG@3 Hz and d_{gap} of 70 mm. (D) Characteristic curves of 9.3 mF capacitor charged by a Gii-TENG @ 3 Hz and d_{gap} of 70 mm with and without using a R_{load} resistor of 40 MW.

### 2.2.4 Autonomous Pressure Sensors Based on Gii-TENG

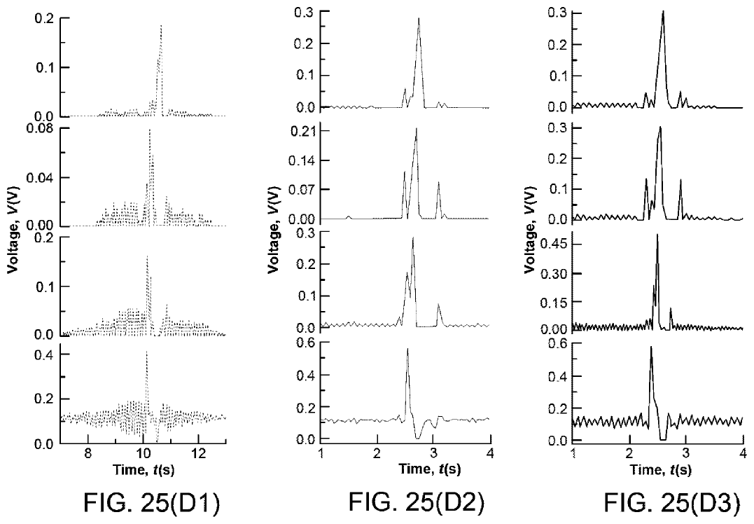

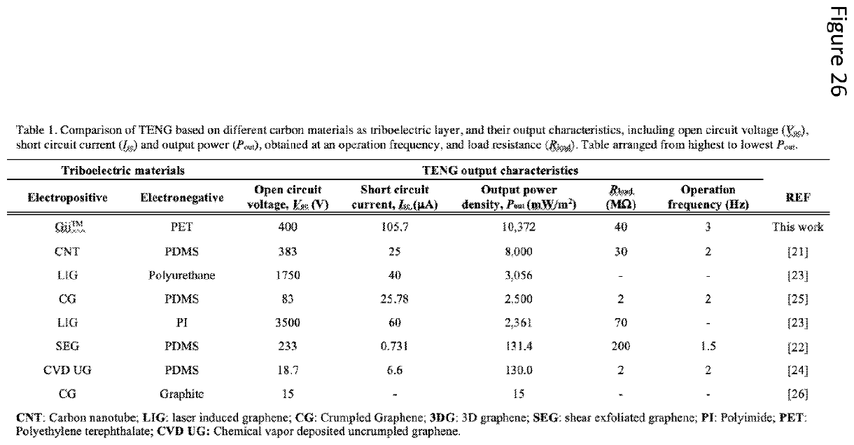

Gii-TENG has been tested as an autonomous pressure sensors. For that, a 4×1 array of sensors has been assembled in a light-weight mat, see FIG. 25(A). The pressure mat was connected to a laptop using Arduino, and an algorithm programmed in Labview allowed to measure the voltage generated by each sensor and to display the results in an interface (see logic diagram in FIG. 25(B). The algorithm was capable of: i) identifying people anonymously, and ii) to recognise if the person is entering or leaving the room. The experiment presented in FIG. 25(C) shows three people with different weights and wearing different shoes/trainers, producing characteristic patterns, see FIG. 25(D). These experimental results demonstrated that Gii-TENG could be used for dynamic pressure sensors in good agreement with previous theoretical works reported in the literature. The key feature of this self-powered mat is the identification of people anonymously, utilising the characteristic pattern generated by the Gii-TENG output voltage.

FIG. 25 re-cap: (a) Photograph of self-powered pressure mat based on 4×1 array of Gii-TENG. (b) Logic diagram of the data acquisition, communication and analysis of mat readings for occupancy monitoring. Photo-frames of person 1 (c1-3), 2 (c4-6) and 3 (c7-9) walking on the pressure mat. (d1-3) Characteristic pressure patterns generated by each person.

### 3. Conclusions

Gii carbon foam has been successfully used as tribopositive electrode in a TENG, exhibiting high Pₒᵤₜ of around 10.37 W/m² which are record values for carbon based TENG. These values where achieved by using a load resistance of 40 MOhms which is an order of magnitude lower resistance than that needed with other variations of graphene based TENG. The study of Gii-TENG output characteristics as a function of applied pressure concluded that porous structure of Gii carbon foam benefited the charge transfer while minimising energy loss. Gii-TENG demonstrated great stability and low material transfer over 15,000 of cyclic mechanical stimulus, preserving almost 100% of the initial output power. This effect exhibited a factor 5 increase of the V_{oc} when the applied pressure between electrodes was increase from 13 to 130 kPa. Moreover, Gii-TENG was successfully utilised to charge energy storage devices and was tested as a self-powered sensors in an energy-autonomous pressure sensitive mat. Gii-TENG has demonstrated great sensitivity to pressure, allowing the fabrication of a pressure mat to anonymously identify people entering/leaving a room, and probing the validity of these devices for dynamic pressure sensing.

1. A method of manufacturing an active layer for a triboelectric nanogenerator (TENG), comprising the steps of:
(a) using a first laser beam to irradiate an encapsulated, sub-surface region of a carbon pre-cursor material below a surface of the carbon pre-cursor material, to create carbon foam in that encapsulated, sub-surface region, and then
(b) using a second laser beam (i) to remove or ablate material sitting above the carbon foam, and (ii) to expose the carbon foam and thereby produce a resultant carbon foam material;
(c) using the resultant carbon foam material as an active layer, such as the electropositive layer, in the triboelectric nanogenerator.

2. The method of claim 1 including the step of using the resultant carbon foam material to form an electropositive, tribopositive or charge collecting active layer in the TENG, in combination with an electronegative or charge generating material in the TENG, such as made from an organic material (e.g., Teflon, PVC, PDMS, PI, PET).

3. The method of claim 1 in which the carbon pre-cursor also forms the electronegative active layer in the TENG.

4. The method of claim 1 in which the carbon pre-cursor material is a polyimide film and polyimide film also forms the electronegative active layer in the TENG.

5. The method of claim 1 in which the carbon pre-cursor is comprised of any of the following: a thermo-setting material, a non-thermo-plastic material, a polyimide film, a polymer, polyimides (for example, poly(4,4′-oxydiphenylene-pyromellitimide), otherwise known as polyimide), polyetherimides (PEI), poly(methyl methacrylate) (PMMA) (e.g., spray-coated PMMA), polyurethanes (PU), polyesters, vinyl polymers, carbonized polymers, photoresist polymers, alkyds, urea-formaldehyde, poly(amic acids) (for example an aryl-containing poly (amic acid)) (for example poly(pyromellitic dianhydride-co-4,4′-oxydianiline), amic acid—otherwise known as polyamic acid); dianhydrides (for example aryl dianhydrides) (for example pyromellitic dianhydride); derivatives of said poly(amic acids); derivatives of said dianhydrides (e.g., derivates of pyromellitic dianhydride), aromatic materials (e.g., aromatic polymers); heteroaromatic materials (e.g., heteroaromatic polymers); polymers containing aromatic moieties; cyclic materials (e.g., polymers containing cyclic moieties); heterocyclic materials (e.g., polymers containing heterocyclic moieties); heteroaromatic materials (e.g., polymers containing heteroaromatic moieties), material including one or more of aromatic bonds, or heteroaromatic bonds or hetero bonds (e.g., imide bonds).

6. The method of claim 1 including the step of functionalising the resultant carbon foam material to increase its surface charge density.

7. The method of claim 1 including the step of doping the resultant carbon foam material to increase its surface charge density.

8. The method of claim 1 including the step of using a hydrogel electrolyte to separate the resultant carbon foam material active layer, from the other active layer.

9. The method of claim 1 in which the resultant carbon foam material is deformable under pressure to enable pressure dependent energy generation by the TENG.

10. The method of claim 1 in which the second laser beam alters or transforms at least some of the carbon foam generated by the first laser beam, to produce the resultant carbon foam material.

11. The method of claim 1 including the step of selecting laser parameters to lead to a resultant carbon foam with properties and morphologies that are suitable for use as an active layer in the TENG.

12. The method of claim 1 in which the TENG is integrated with a capacitor whose electrodes are made of the resultant carbon foam material.

13. The method of claim 1 in which the TENG and a capacitor are formed on the same flexible polymer substrate.

14. The method of claim 1 in which the TENG is integrated with a rechargeable battery.

15. The method of claim 1 in which the TENG is configured to output a signal that measures one or more of: pressure, shear, stretch, bend, or twist.

16. The method of claim 1 in which the resultant carbon foam material is deformable under pressure to enable pressure dependent energy generation by the TENG.

17. The method of claim 1 in which the TENG is a self-powered autonomous pressure sensor e.g. for anonymous room occupancy.

18. The method of claim 1 in which the TENG is configured to operate as an energy harvester.

19. The method of claim 1 in which the TENG is configured as the power source for an IOT device.

20. The method of claim 1 in which the TENG is integrated into a floor mat that generates power when a person walks on the floor mat.

21. The method of claim 1 in which the TENG is integrated into a wearable device, or into a seat and is then configured to output a signal when a person sits on the seat.

22. The method of claim 1 in which the TENG is configured to output a signal that measures presence of a chemical or gas.

23. The method of claim 1 in which the TENG is combined with a supercapacitor configured for generating burst power sufficient for wireless data transmission, and the electrodes of the supercapacitor are also made from the same resultant carbon foam material.

24. The method of claim 1 in which the TENG has at least 95% output power retention over 15 k cycles.

25. The method of claim 1 in which the TENG has a maximum output power of at least 10 W/m², using an external load resistance of 40 MOhms.

26. The method of claim 1 in which the TENG has a triboelectric charge density of at least 1 mC/m².

27. The method of claim 1 in which the TENG has a triboelectric response that showed maximum open-circuit voltage (Voc) and short-circuit current (Isc) of 400 V and 105.7 mA respectively when stimulated at 3 Hz (contact-separation frequency) and 70 mm (optimum gap distance).

28. The method of claim 1 in which the resultant carbon foam material is a non-graphene turbostratic multilayer foam.

29. A triboelectric nanogenerator (TENG) manufactured using the method defined in claim 1.

30. A triboelectric nanogenerator (TENG) in which (i) a carbon foam material forms an active layer, such as the electropositive layer, and (ii) the carbon foam material is a non-graphene turbostratic multilayer foam and (iii) the performance of the TENG conforms to any one or more of the following: (a) the TENG has at least 95% output power retention over 15 k cycles; (b) the TENG has a maximum output power of at least 10 W/m², using an external load resistance of 40 MOhms; (c) the TENG has a triboelectric charge density of at least 1 mC/m2; (d) the TENG has a triboelectric response that shows maximum open-circuit voltage (Voc) and short-circuit current (Isc) of 400 V and 105.7 mA respectively when stimulated at 3 Hz (contact-separation frequency) and 70 mm (optimum gap distance).
